(19) United States
(12) Patent Application Publication
(10) Pub. No.: US 2008/0140608 A1
(43) Pub. Date: Jun. 12, 2008

(54) Information Managing Apparatus, Method, and Program

(75) Inventors: Masanari Takahashi, Chiba (JP); Hiroaki Homma, Chiba (JP)

Correspondence Address: CANTOR COLBURN, LLP, 20 Church Street, 22nd Floor, Hartford, CT, 06103, US

(73) Assignee: TOYO ENGINEERING CORPORATION, Chiba (JP)

(21) Appl. No.: 11/662,701

(22) PCT Filed: Sep. 13, 2004
(86) PCT No.: PCT/JP04/13337

§ 371 Date: Mar. 13, 2007

(51) Int. Cl. G06F 17/30

(52) U.S. Cl. 707/2; 707/E17.005

(57) ABSTRACT

An information management apparatus of the present invention including a database DB1, in which document information and keywords which have been correlated to the document information in order to search for the document information are electronically saved, a copy unit that copies the document information and the keywords from the DB1 at the same time, a keyword temporary storage unit that stores the copied document information and keywords, a keyword acceptance unit that accepts entry of the keyword selected from a list of keyword options displayed on a keyword entry screen as a keyword to be correlated to the copied document information, a notification unit that prompts entry of the keyword from the keyword option list displayed on the keyword entry screen when the document information is copied, and a registration unit that stores the keywords in the storage unit into a database DB2 in a condition where they are correlated to the document information in the storage unit, wherein the keywords in the storage unit are given an addition of or changed to the keyword accepted by the keyword acceptance unit.

### TECHNICAL FIELD

The present invention relates to a technology for electronically saving and managing document information.

### BACKGROUND ART

Recently, documents such as a variety of repots and technological materials in an organization such as a corporate have mainly been managed and saved in an electronic form instead of a form of paper. Along with such a trend, an information managing apparatus is available as described in, for example, Patent Document 1 that can efficiently make a database of a vast amount of document information in different formats systematically and handle document information updated day by day. A configuration of a main part of elements of the information managing apparatus described in this document is shown in FIG. 27. In this information managing apparatus, an ID is retrieved from a person in charge information DB 1405 by an ID retrieving unit 1402 using a login name accepted by a login acceptance unit 1401 as a key. Using the retrieved ID as a key, an important keyword extraction unit 1403 extracts an important keyword based on information stored in a search history DB 1406. The extracted important keyword is highlighted by the ID retrieving unit 1402.

A keyword list selection unit 1407 selects a keyword list (keyword group), which corresponds to a department to which a user belongs, from among an organization DB 1409, using the retrieved ID as a key. The selected keyword group is put on a predetermined template by a keyword list display unit 1408. Information retrieved by a highlighting unit 1404 and by the keyword list display unit 1408 is sent to a display unit 1411, to present a keyword list screen to a user 1420.

FIG. 28 is a schematic block diagram of a search execution unit in a conventional information managing apparatus. This apparatus includes a search execution unit 1520, a search result display unit 1525, a database control unit 1526, and a report information DB (database) 1527. The search execution unit 1520 includes a keyword search unit 1521, an integrated search unit 1522, and a cross-reference search unit 1523. In the report information DB 1527, a variety of information to be contained in a report, that is, report information, is stored. The search execution unit 1520 retrieves and extracts necessary information from the report information DB 1527 via the database control unit 1526. Search includes the keyword search unit 1521 that searches for technical terms and the integrated search unit 1522 that searches for a bibliographic terms of reports. Search results of these searches may be utilized independently or can be cross-referenced to limit the information further. Such search results thus obtained are presented to the user via the search result display unit 1525.

FIG. 29 shows one example of a search screen (in which some of keywords are not shown in the drawings), from which, an integrated search, a keyword search, and an ID search can be executed. A keyword search is executed by entering a predetermined keyword into a keyword entry field (“SEARCH WORD” field) arranged on the left side of the screen of FIG. 29. This entry is completed when the keyword is displayed in a keyword selection window in a top left field of FIG. 29 by clicking on the keyword shown in the search screen. According to such an entry format, a keyword can be selected easily and displayed in the keyword selection window immediately after being entered and at the same time, a hit count is displayed beside it, which makes operations efficient.

It is to be noted that the way to entry is not limited to this but other ways, such as to write a keyword in the keyword selection window or to provide a radio button beside a keyword display field so that a keyword may be entered when this button is clicked, may be employed. In this example, up to five keywords can be entered. A keyword can be selected from options displayed on this screen. The keyword options are classified into large items such as material name keywords and brand keywords, which are each segmented into small items further. The number of report documents, on which selected keyword has been hit, is displayed at a midsection of the screen. In this example, a hit count for the report documents has been 1245 with a first keyword and 355 with a second keyword.

### [Patent Document 1] Japanese Laid-open patent publication NO. 2003-76676

### DISCLOSURE OF THE INVENTION

However, the above-described conventional technology described in the above document has a room for improvement in terms described bellow.

First, in an organization, a document is rarely created from scratch but generally created based on a document form. By copying a keyword attached beforehand to a document when copying the form, it is possible to save labor of attaching a keyword to the copied document. However, according to such a keyword attaching method, resultantly an unrealistic and inappropriate keyword may be attached, thus leading to a problem that necessary information may not be found through such a keyword search.

Second, even in the same organization, different keywords may be attached to even the same document depending on the departments for better efficiency, so that it has been necessary to prompt each department to attach its own keyword respectively.

Third, with a recent trend of year-by-year increasing capacities of computerized document information, a vast amount of information must be managed. To utilize such document information, it is necessary to manage the information systematically. Further, it is desired to efficiently search a database of a vast amount of document information for necessary document information from different perspectives.

In view of the above-described situation, the present invention has been developed, and it is an object of the present invention to provide an information management apparatus that can improve efficiency of a keyword search of document information.

According to the present invention, there is provided an information management apparatus including a database, in which document information relating to documents and keywords which have been correlated to said document information in order to search for the document information are electronically saved, a copying unit that copies the document information retrieved from said database and also copies said keywords at the same time, a storage unit that temporarily stores said document information and said keywords copied by said copying unit, a keyword acceptance unit that accepts entry of the keyword selected from a list of keyword options displayed on a keyword entry screen as a keyword to be correlated to said document information copied by said copying unit, a notification unit that prompts entry of the keyword from the keyword option list displayed on said keyword entry screen when said document information and said keywords are copied by said copying unit, and an information registration unit that stores said keywords in said storage unit into said database in a condition where they are correlated to the document information in said storage unit, wherein said keywords in said storage unit are given an addition of or changed to said keyword accepted by said keyword acceptance unit.

It is to be noted that document information refers to a variety of kinds of information that constitutes a document, for example, information including a summary of the document, bibliographic information of the document and the like. Further, if the document has a related material, information of a link-destination of the related material of the document may be further included. The document information is saved in a database in a format of a variety of kinds of document files, image files, audio files and the like. The document information may be saved in an archive file format or compressed file format, in which a plurality of files are put together.

The keyword option list is a list screen, which presents a list to indicate options of a keyword to be attached to document information. The keyword options are displayed in a list on the same screen.

According to the present invention, in copying of document information in a database, a keyword is copied together with the document information and a user is also prompted to enter a keyword, so that the user is certainly caused to give an addition of the copied keyword or change to it. Accordingly, as compared to a case where a keyword of a copied document is registered as it is, a more appropriate keyword can be attached, increasing significance and thus keyword search efficiency can be improved.

The above information managing apparatus may include a keyword presentation unit that highlights a keyword correlated to said document information on said keyword entry screen.

It is to be noted that highlighting may be reversed display, highlight display, blinking display, different color display or the like.

In this configuration, keywords correlated to document information are highlighted on a displayed list, thereby facilitating visual confirmation of the keywords and usability is improved.

The above information management apparatus may include a decision unit that decides whether said keyword is changed by accessing to said storage unit when said document information and said keyword are copied and a prohibition unit that prohibits said information registration unit from storing said document information into said database when said decision unit decided that said keyword was not changed.

It is to be noted that the decision unit may read a keyword, which was copied from the database and stored in the storage unit, compare the keyword with a keyword accepted by the keyword acceptance unit, and when they do not match, decide that the keyword has been changed. Further, in the keyword comparison, their character string codes may be compared or data sizes of these keyword character strings may be compared. Alternatively, when a keyword stored in the storage unit has been stored as an identification code that corresponds to a list of keywords determined beforehand, their identification codes can be compared. Further alternatively, the decision unit may monitor whether, after a keyword is copied from the database, another keyword is written into the storage unit and, if such is the case, decide that the keyword has been changed.

By this configuration, when document information has been copied, the user can be caused to give an addition of or change keywords, more certainly.

The above information management apparatus may include a deletion unit that, can delete said document information and said keyword as copy source after said document information and said keyword were copied by the copying unit.

By this configuration, in the case of moving document information, by giving addition of or changing keyword before movement, thus, it is possible to attach a different keyword to the document information after movement, to make this keyword more appropriate, thereby improving search efficiency.

In the above information management apparatus, said document information and said keyword copied by said copying unit may be copied into a database different from the database as copy source.

By this configuration, the document information can be copied to or moved into other databases, in which case also an appropriate keyword can be attached to the document information after copying or after movement.

The above information management apparatus may include a keyword type acceptance unit that accepts switching between lists of pluralities of kinds of keyword options to be displayed on said keyword entry screen, wherein said keyword presentation unit displays on said keyword entry screen a list of keyword options corresponding to a type accepted by said keyword type acceptance unit and displays a keyword correlated to said document information from among said options in highlight, so that said keyword acceptance unit can accept the keyword selected from said keyword option list displayed on said keyword entry screen.

By this configuration, by selecting an appropriate keyword option list from among various keyword option lists, a keyword can be attached to document information, so that it is possible to attach a keyword appropriate to a database in which the document information is to be saved.

In the above information management apparatus, said storage unit may contain a plurality of keyword storage units that correspond to said plurality of kinds of keyword option lists, to respectively store keywords accepted by said keyword acceptance unit as keywords specific to types accepted by said keyword type acceptance unit in the keyword storage units that correspond to the keyword types, and said information registration unit can store the keywords in said database corresponding to the type as keywords specific to the types accepted by said keyword type acceptance unit in a condition where the keywords are respectively correlated to said document information.

By this configuration, for example, it is possible to register keywords attached from different perspectives in a condition where they are respectively correlated to one piece of document information, so that the document information can be searched with the keywords from the various perspectives, thereby improving usability.

According to the present invention, there is provided an information management apparatus including a database, in which document information relating to documents and keywords which have been correlated to said document information in order to search for the document information are electronically saved, an attribute presentation unit that presents contents of two different attributes, first and second ones, to be attached to said document information in order to classify said document information, an attribute acceptance unit that accepts said first and second attributes to be attached to said document information, based on said contents of said first and second attributes presented by said attribute presentation unit, a keywords list storage unit that stores first and second keyword option lists that correspond to said first and second attributes respectively, a list switching acceptance unit that accepts switching between said first and second keyword option lists to be displayed on a keyword entry screen, a keyword acceptance unit that accepts, as a keyword to be correlated to said document information, entry of the keyword selected from the keyword option list displayed as a result of the switching on said keyword entry screen, an information registration unit that stores said keyword accepted by said keyword acceptance unit and said first and second attributes accepted by said attribute acceptance unit into said database in a condition where they are correlated to said document information, a target acceptance unit that accepts designation of said first and second attributes, in order to determine the document information to be a search target, a search keyword acceptance unit that accepts keyword which is used in search, from said first and second keyword option lists respectively, a search unit that extracts the document information that corresponds to said keyword by searching from said document information having said attributes accepted by said target acceptance unit as the search target, and an information presentation unit that presents said document information searched by said search unit, separately in each of said first attributes or for each of said second attributes.

It is to be noted that attributes may include first attributes which are attached to classify document information pieces into units such as a project name, a client name, and a document name and second attributes which are attached in order to classify the document information pieces into items such as a process name, an item name, and a chapter (table of contents).

By this configuration, the document information pieces can be registered in a condition where they are classified using the two attributes and also in a condition where they are correlated to keywords from different keyword option lists corresponding to the attributes, so that it is possible to search for the document information by accepting search keywords using the different keyword option lists from different perspectives and thus the document information can be searched from various perspective by using an appropriate keyword, thereby improving search efficiency.

The above information management apparatus may include a copying unit that copies document information from said database and copying said keyword at the same time and a notification unit that prompts entry of the keyword from said first or second keyword option list displayed on said keyword entry screen when said document information and said keyword have been copied by said copying unit.

By this configuration, in the case of copying document information, it is possible to make surely the user add or change a keyword to be copied together with the document information, so that it is possible to attach a more appropriate keyword than the case of registering a keyword of a copied document as it is, to increase significance of the keyword, thereby improving keyword search efficiency.

According to the present invention, there is provided an information management method for electronically saving, into a database, document information relating to documents and keywords which have been correlated to the document information in order to search for this document information and managing them, said method comprising copying the document information retrieved from said database and also copying said keywords at the same time, temporarily storing said document information and said keywords which have been copied, into a storage unit, accepting entry of the keyword selected from a list of keyword options displayed on a keyword entry screen as a keyword to be correlated to said copied document information, prompting entry of the keyword from the keyword option list displayed on said keyword entry screen when said document information and said keywords are copied, storing said keywords in said storage unit into the database in a condition where they are correlated to the document information in said storage unit, and giving an addition of or changing said keywords in said storage unit to said keyword accepted by said keyword acceptance unit.

According to the present invention, there is provided an information management method for managing a database which m electronically saves therein document information about a document and keywords which have been correlated to this document information in order to search for this document information, said method comprising presenting contents of two different attributes, first and second ones, to be attached to said document information in order to classify said document information, accepting said first and second attributes to be attached to said document information, based on said contents of said first and second attributes presented in said presenting the contents, storing first and second keyword option lists that correspond to said first and second attributes respectively, into a keyword list storage unit, accepting switching between said first and second keyword option lists to be displayed on a keyword entry screen, accepting, as a keyword to be correlated to said document information, entry of the keyword selected from the keyword option list displayed as a result of the switching on said keyword entry screen, storing said keyword accepted in said accepting the entry of the keyword and said first and second attributes accepted in said accepting the attribute into said database in a condition where they are correlated to said document information, specifying said first and second attributes and accepting them as a search range when searching said database for said document information saved in it, accepting the keyword which is used in search, from said first and second keyword option lists respectively, searching the document information saved in said search range accepted by said accepting the search range, for such document information as to correspond to said keyword, and presenting said document information searched in said searching the document information, separately in each of said first attributes or for each of said second attributes.

According to the present invention, there is provided an information management program for controlling an apparatus that electronically saves, into a database, document information relating to documents and keywords which have been correlated to the document information in order to search for the document information and manages them, said program causing this apparatus to perform copying the document information retrieved from said database and also copying said keywords for this apparatus at the same time, temporarily storing said document information and said keywords which have been copied in said copying the document information, into a storage unit, accepting entry of the keyword selected from a list of keyword options displayed on a keyword entry screen as a keyword to be correlated to said document information copied in said copying the document information, prompting entry of the keyword from the keyword option list displayed on said keyword entry screen when said document information and said keywords have been copied in said copying the document information, storing said keywords in said storage unit into the database in a condition where they are correlated to the document information in said storing unit, and changing said keywords in said storage unit to or giving an addition of said keyword accepted in said accepting the keyword.

According to the present invention, there is provided an information management program for controlling an apparatus that electronically saves, into a database, document information relating to documents and keywords which have been correlated to the document information in order to search for the document information and manages them, said program performing presenting contents of two different attributes, first and second ones, to be attached to said document information in order to classify said document information, accepting said first and second attributes to be attached to said document information, based on said contents of said first and second attributes presented in said presenting the contents, storing first and second keyword option lists that correspond to said first and second attributes respectively, into a keyword list storage unit, accepting switching between said first and second keyword option lists to be displayed on a keyword entry screen, accepting, as a keyword to be correlated to said document information, entry of the keyword selected from the keyword option list displayed as a result of the switching on said keyword entry screen, storing said keyword accepted in said accepting the entry of the keyword and said first and second attributes accepted in said accepting the attribute into said database in a condition where they are correlated to said document information, specifying said first and second attributes and accepting them as a search range when searching said database for said document information saved in it, accepting the keyword which is used in search, from said first and second keyword option lists respectively, searching the document information saved in said search range accepted in said accepting search range, for such document information as to correspond to said keyword, and presenting said document information searched in said searching the document information, separately in each of said first attributes or for each of said second attributes.

According to the present invention, there is provided an information management apparatus which can improve efficiency of a keyword search for a keyword of document information.

### BRIEF DESCRIPTION OF THE DRAWINGS

The above-described objects and the other objects as well as features and advantages will be more apparent from the following best modes and the accompanying drawings set forth below.

FIG. 1 is a configuration diagram showing a network configuration of an embodiment of an information management apparatus according to the present invention;

FIG. 2 is a schematic configuration block diagram of the information management apparatus of FIG. 1;

FIG. 3 is a schematic functional block diagram of the information management apparatus of FIG. 1;

FIG. 4 is a diagram showing one example of a keyword entry screen of the information management apparatus of FIG. 1;

FIG. 5 is a diagram showing one example of a keyword prompt screen of the information management apparatus of FIG. 1;

FIG. 6 is a flowchart showing one example of operations of the information management apparatus of FIG. 1;

FIG. 7 is a flowchart showing operations following the operation shown in the flowchart of FIG. 6;

FIG. 8 is a diagram showing a condition where a keyword has been newly selected on the keyword entry screen of the information management apparatus of FIG. 4;

FIG. 9 is a functional block diagram showing a configuration of a main part of elements of an embodiment of the information management apparatus according to the present invention;

FIG. 10 is a functional block diagram showing a configuration of a main part of elements of an embodiment of the information management apparatus according to the present invention;

FIG. 11 is a diagram showing one example of the keyword entry screen of the information management apparatus of FIG. 10;

FIG. 12 is a diagram showing an example in which different keyword lists are displayed on the keyword entry screen of FIG. 11;

FIG. 13 is a flowchart showing one example of operations of the information management apparatus of FIG. 10;

FIG. 14 is a functional block diagram showing a configuration of a main part of elements of an embodiment of the information management apparatus according to the present invention;

FIG. 15 shows a structure of a registration table of the information management apparatus of FIG. 14;

FIG. 16 is a functional block diagram showing a configuration of a main part of elements of an embodiment of the information management apparatus according to the present invention;

FIG. 17 is a functional block diagram showing the configuration of a main part of elements of the information management apparatus of FIG. 16;

FIG. 18 is an explanatory diagram of a structure of classifying document information which is managed by the embodiment of the information management apparatus according to the present invention;

FIG. 19 shows one example of a document registration screen of the information management apparatus of FIG. 16;

FIG. 20 shows a structure of a registration table of the information management apparatus of FIG. 17;

FIG. 21 is a flowchart showing one example of operations of the information management apparatus shown in FIGS. 16 and 17;

FIG. 22 is a functional block diagram showing a configuration of a main part of elements of an embodiment of the information management apparatus according to the present invention;

FIG. 23 is a diagram showing one example of a search keyword specification screen of the information management apparatus of FIG. 22;

FIG. 24 is a diagram showing one example of a search result list screen of the information management apparatus of FIG. 22;

FIG. 25 is a flowchart showing one example of operations of the information management apparatus of FIG. 22;

FIG. 26 shows a flowchart showing following operations of the flowchart of FIG. 25;

FIG. 27 is a diagram showing a configuration of a main part of elements of the conventional information management apparatus;

FIG. 28 is a schematic configuration diagram of a search execution unit in the conventional information management apparatus of FIG. 27; and

FIG. 29 is a diagram showing one example of a search screen of the conventional information management apparatus of FIG. 27.

### BEST MODE FOR CARRYING OUT THE INVENTION

An embodiment of the present invention will be described below with reference to drawings. Similar reference symbols are given to similar components, and descriptions on the similar components will not be repeated.

### First Embodiment

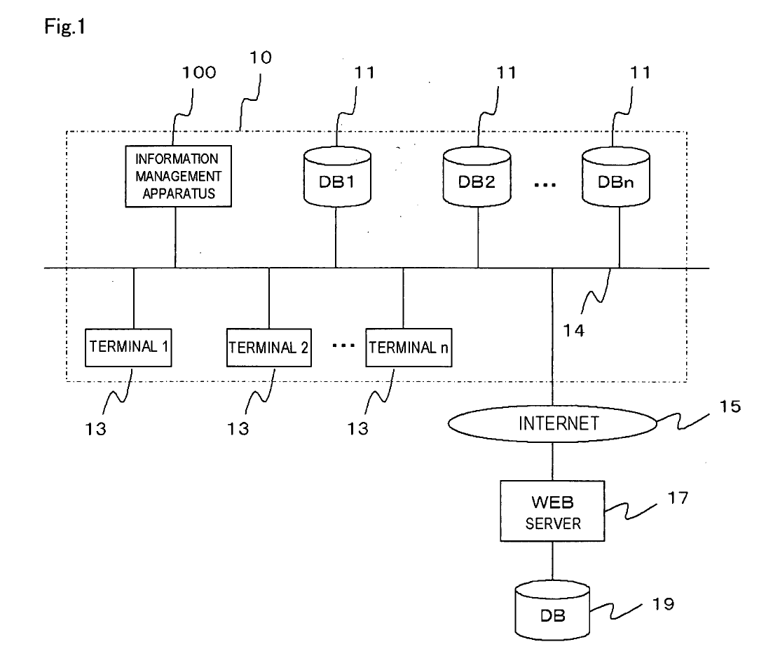

FIG. 1 is a configuration diagram showing a network configuration of an embodiment of an information management apparatus according to the present invention. An information management system 10 includes an information management apparatus 100, a plurality of databases 11 (which are indicated as “DB1”, “DB2”, and “DBn” in the drawings), and a plurality of terminals 13 (which are indicated as “terminal 1”, “terminal 2”, and “terminal n” in the drawings). The information management system 10, the databases 11, and the terminals 13 are connected to each other via a network 14, thus permitting information of the databases 11 to be shared by the information management apparatus 100 and the terminals 13.

The information management apparatus 100 searches for document information saved in the databases 11 by using a keyword and presents the thus retrieved document information. Further, when searching for the document information saved in the databases 11, this apparatus presents keyword options displayed as a list, to accept entry of the keyword selected from the displayed list of the keyword options. All of the keyword options may be displayed as a list on the same screen.

It is to be noted that the document information refers to a variety of kinds of information that constitutes a document, for example, information including a summary of the document, bibliographic information of the document and the like. Further, if the document has a related material, it may further include information of a link-destination of related material of the document may be further included. The document information is saved in a database in a format of a variety of kinds of document files, image files, audio files and the like. The document information may be saved in an archive file format or compressed file format, in which a plurality of files are put together. Further, the keywords are saved in the databases 11 in a condition where they are correlated to document information in order to search the databases 11 for this document information. A plurality of the keywords may be correlated to a pieces of document information.

Further, the document information may be a variety of kinds of data as well as data containing a document and a drawing. In particular, in a case where the document information is such data as to be accumulated for a long period or require rapidness in handling, the present invention gives more distinguished effects. Such data may be exemplified by a technological report, a business material, a trouble report, a consulting report, a business trip report, safety management material, an operation management material of plants and equipment and the like, a medical record, patent information, judicial verdict information and the like.

Further, the information management apparatus 100 may copy and move the document information saved in the databases 11 and, when doing so, can attach a keyword also to newly created document information so that this keyword may be used in search. Also when attaching this keyword, this apparatus presents keyword options displayed as a list, to accept entry of the keyword selected from among the keyword options displayed as the list.

It is to be noted that the information management apparatus 100 may be, for example, a WEB server 17 or a service provider on the Internet 15. Although the present embodiment will be described with reference to a case where the apparatus related to the present invention is provided in order to share information in a client server system, the present invention is not limited to it. For example, the present invention may be applied to a standalone type apparatus.

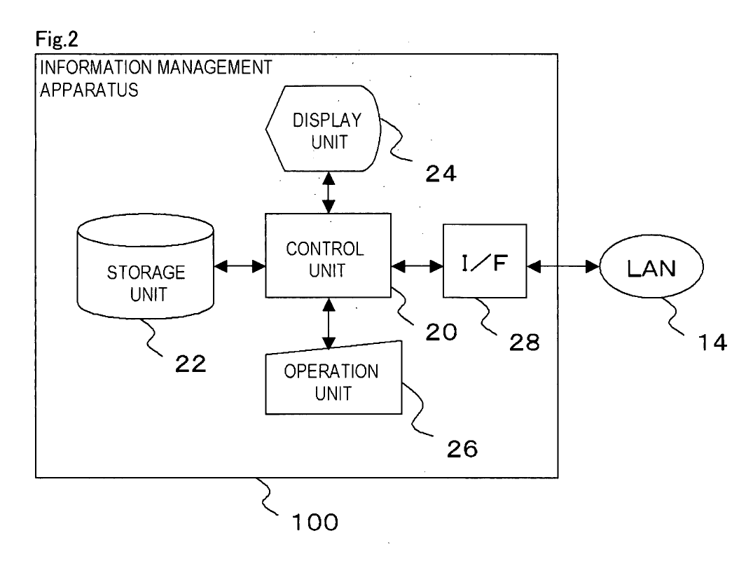

FIG. 2 is a schematic configuration block diagram of the present embodiment of the information management apparatus 100. The information management apparatus 100, which may be a personal computer, a workstation, or an office computer, includes a control unit 20, a storage unit 22, a display unit 24, an operation unit 26, and an interface unit 28.

The control unit 20 is, for example, a CPU, to control an entirety of the information management apparatus 100 with its elements. The storage unit 22 includes a hard disk device which stores a program, a main memory with a region which is used to read the program from the hard disk device and temporarily store it or execute it, and other external storage devices including a floppy (registered trademark) disk, an MO, a CD-R (RW), a DVD-R (RW), and a magnetic tape.

The display unit 24, which is a CRT monitor or a liquid crystal display, for example, serves to display various kinds of information, an operation screen, and operations and states of the information management apparatus 100. The operation unit 26, which is a keyboard, a mouse, a tablet, an operation button, a switch, a lever, or a touch panel, for example, is operated by a user of the information management apparatus 100 for various setting and designating input to it. The operation unit 26 accepts these operations. The information management apparatus 100 may further include a user interface including an audio input/output unit (not shown) such as a speaker or a microphone and a video input unit (not shown) such as a digital camera. It may further include an audio processing unit, a recording unit, a reproduction unit, and a video processing unit, which are not shown.

The interface unit 28 is connected to the network 14 such as a LAN, to communicate with any other device on the network 14.

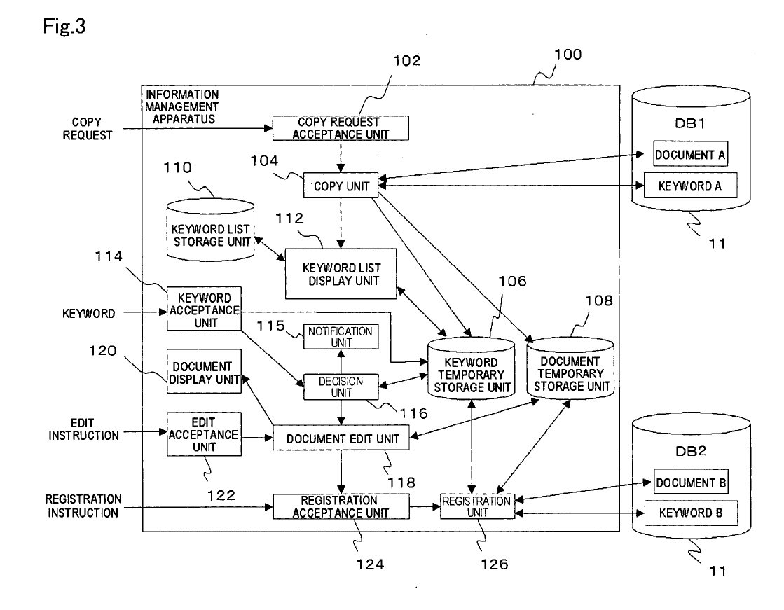

FIG. 3 is a schematic functional block diagram of the present embodiment of the information management apparatus 100. The information management apparatus 100 includes a copy request acceptance unit 102, a copy unit 104, a keyword temporary storage unit 106, a document temporary storage unit 108, a keyword list storage unit 110, a keyword list display unit 112, a keyword acceptance unit 114, a notification unit 115, a decision unit 116, a document edit unit 118, a document display unit 120, an edit acceptance unit 122, a registration acceptance unit 124, and a registration unit 126.

It is to be noted that a configuration of elements not related to an essence of the present invention is not shown in the drawings.

Further, each the constitutional elements of the information management apparatus 100 may be realized by an arbitrary combination of hardware and software mainly with an arbitrary computer CPU, a memory, and a program loaded on the memory to realize constitutional elements in the drawing, a storage unit such as a hard disk to store this program, and a network connecting interface. And it will be appreciated by those skilled in the art that there are a lot of variants of a method and an apparatus for the realization. The respective drawings described below show function-specific blocks, not hardware-specific configurations.

The copy request acceptance unit 102 accepts a copy request to copy document information from a certain one of the databases 11 (DB1 here) to another of them (DB2 here) from the operation unit 26. The copy request contains an instruction to designate a document as a copy source.

The copy unit 104 copies the document information from the databases 11 and, at the same time, copies a keyword correlated to the document information.

The keyword temporary storage unit 106 temporarily stores a keyword copied by the copy unit 104. The document temporary storage unit 108 temporarily stores the document information copied by the copy unit 104. The keyword list storage unit 110 stores a keyword list to be displayed on a keyword list display.

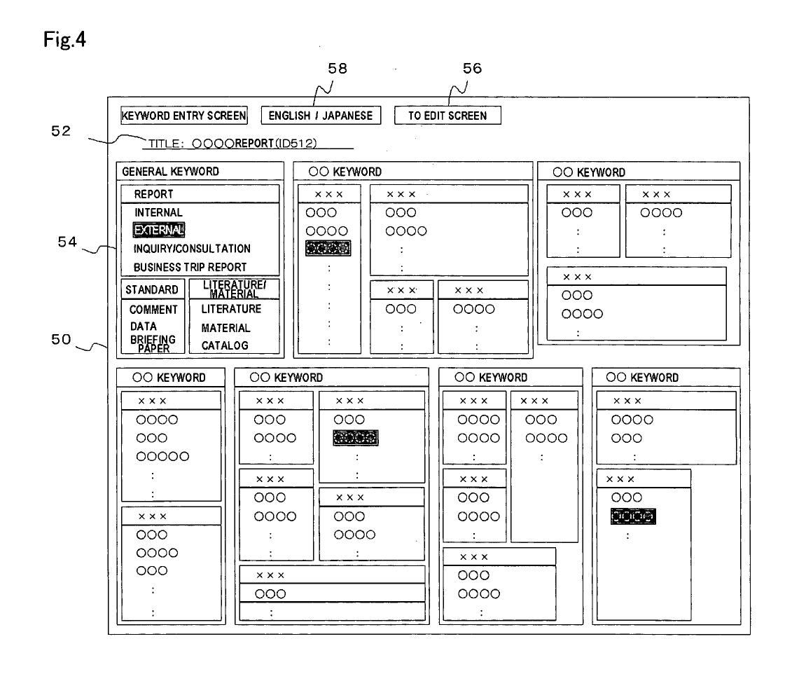

The keyword list display unit 112 displays the keyword, entry screen on the display unit 24 using the keyword list stored in the keyword list storage unit 110. FIG. 4 is a diagram showing one example of the keyword entry screen. The keyword entry screen 50 includes a title 52, a keyword list 54, an edit button 56, and a language switchover button 58. The title 52 indicates a title of a document copied by the copy unit 104. The keyword list 54 includes all keyword lists stored in the keyword list storage unit 110 and is displayed. In the keyword list 54, keywords, designated for a document given at the title 52, are highlighted in reversed display, highlight display, blinking display, different color display or the like.

As shown in FIG. 4, in the present embodiment, options of all keywords are displayed on the same screen. Further, on this keyword entry screen 50, a plurality of keywords are divided into several fields and grouped. Also, the keywords having different breadths of concepts, that is, a major concept, a middle concept, and a minor concept are displayed and paratactically arranged on the same screen. Due to such display, it is possible to prompt those who enter information to enter a plurality of keywords having different categories.

The edit button 56 is an operation button to switch to a document edit screen after a keyword is designated. The language switchover button 58 is an operation button to switch a language in which a keyword is displayed in the keyword list 54 between English and Japanese.

Further, such a configuration may be employed that a keyword reference table may be created and an identification number is given to each of keywords. In the reference table, Japanese keywords and keywords given in a foreign language such as English that correspond to these identification numbers are stored respectively. It is thus possible to handle both reports written in Japanese and the foreign language by using a single database. For example, when a Japanese keyword has been specified, the corresponding keyword given in a foreign language such as English can be displayed on a search screen simultaneously.

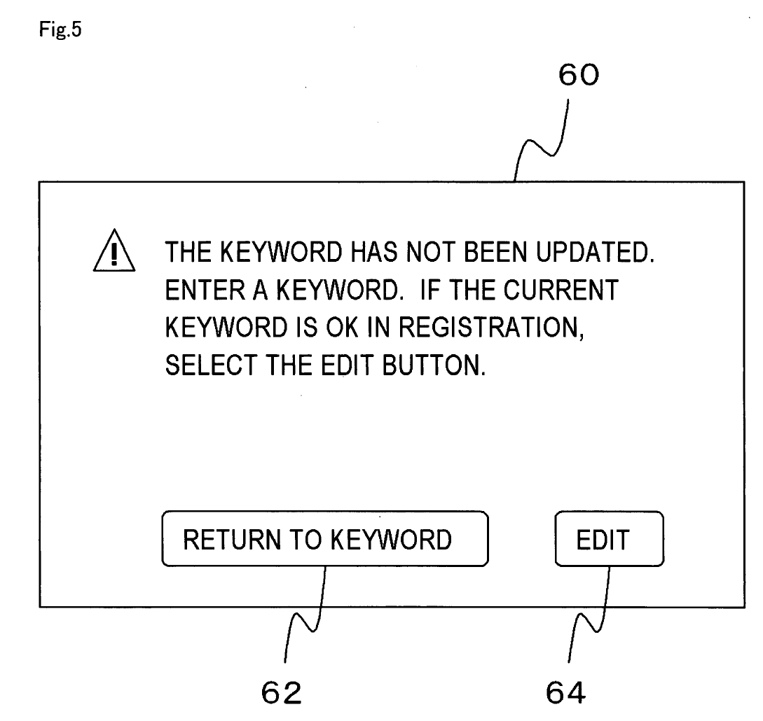

Referring back to FIG. 3, the keyword acceptance unit 114 accepts a keyword selected from the keyword list 54 of FIG. 4 and stores it in the keyword temporary storage unit 106. When a keyword attached to document information copied by the copy unit 104 has not been changed on the keyword entry screen 50, the notification unit 115 notifies that the keyword has not been changed. For example, the notification unit 115 displays a keyword prompt screen 60 shown in FIG. 5 on the display unit 24. The keyword prompt screen 60 includes a return button 62 and an edit button 64. The return button 62 is an operation button to return to the keyword entry screen 50 on which keywords are entered. The edit button 64 is an operation button to switch to document edition without changing keywords.

Referring back to FIG. 3, when the operation unit 26 accepts an operation of the edit button 56 of FIG. 4, the decision unit 116 decides whether a keyword copied by the copy unit 104 has been changed with the keyword accepted by the keyword acceptance unit 114. When the keyword has been changed, the decision unit 116 switches to the document edit screen and, when it has not been changed, causes the notification unit 115 to notify that the keyword has not been changed.

The document edit unit 118 edits the document information stored in the document temporary storage unit 108. The document display unit 120 displays a document information edit screen, not shown, on the display unit 24. The user can edit documents on the document information edit screen. The edit acceptance unit 122 accepts an operation of editing the document information by the user operating the operation unit 26. The document edit unit 118, the document display unit 120, and the edit acceptance unit 122 may be realized by opening a document by activated a general software such as word processor, spreadsheet software, editor, image edit tool and the like that can be executed on a personal computer etc.

The registration acceptance unit 124 accepts a registration instruction to register the document information stored in the document temporary storage unit 108 into any other database DB2. The registration instruction contains a database, folder, and a file name designated as a copy destination for storing the copied document. The registration unit 126 registers a keyword stored in the keyword temporary storage unit 106 into the database DB2 in a condition where it is correlated to document information stored in the document temporary storage unit 108.

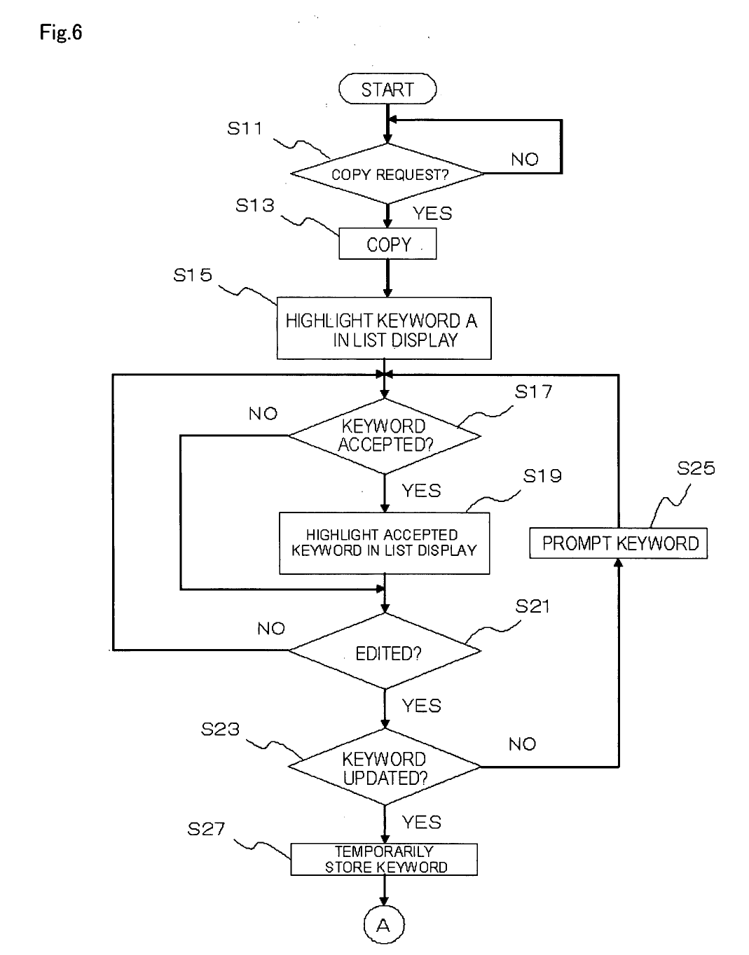

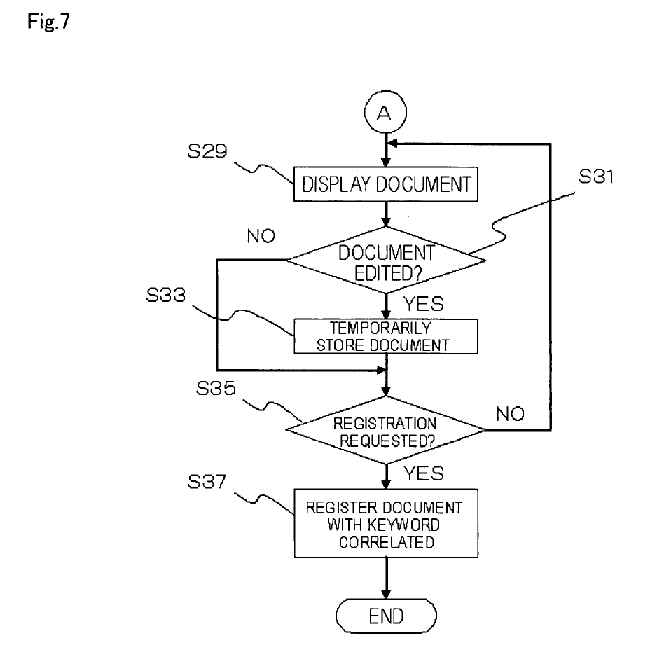

Operations of the thus configured information management apparatus 100 will be described below with reference to the drawings. FIGS. 6 and 7 are flowcharts showing one example of the operations of the present embodiment of the information management apparatus 100.

The following will describe a case where a document A in the database DB1 is copied and registered into the database DB2. Although in the present embodiment, a document in the database DB1 is registered into another database DB2, the present invention is not limited to it. A document in the database DB1 may be copied and registered into the same database DB1.

As shown in FIG. 6, first, when the copy request acceptance unit 102 accepts a copy request for a document (YES at S1), the copy unit 104 copies the document A and a keyword A of the document A in the database DB1 and stores them in the document temporary storage unit 108 and the keyword temporary storage unit 106 respectively (S13). Subsequently, the keyword list display unit 112 highlights the keyword A of the copied document A in the keyword list 54 on the keyword entry screen 50 (S15).

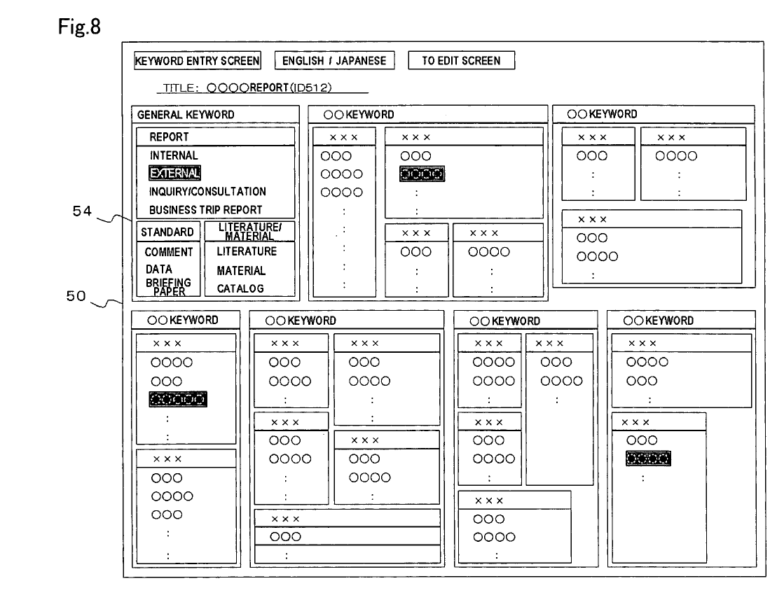

Subsequently, when the keyword acceptance unit 114 accepts a keyword selected from the keyword list 54 on the keyword entry screen 50 (YES at 817), the keyword list display unit 112 highlights the keyword selected from the keyword list 54 on the keyword entry screen 50 (S19). A desired keyword can be selected by, for example, a user moving a mouse pointer on the keyword entry screen 50 to this keyword through manipulation of the operation unit 25 such as a mouse and clicking the mouse on it. The selection can be canceled by clicking again on the keyword in selected state. For example, as shown in FIG. 8, keywords newly selected from the keyword list 54 on the keyword entry screen 50 are highlighted.

Referring back to FIG. 6, when the operation unit 26 accepts an operation of the edit button 56 (YES at S21) after step S19, the decision unit 116 decides whether the copied keyword A has been updated (S23). When the decision unit 116 decides that the keyword has been updated (YES at S23), the updated keyword is stored in the keyword temporary storage unit 106 (S27) and screen is switched to document edit.

On the other hand, when the keyword is not accepted at step S17 (NO at S17), the process goes to step S21. When the edit operation is not accepted at step S21 (NO at S21), the process returns to step S17. Further, when the decision unit 116 decides that the keyword has not been updated at step S23 (NO at S23), the notification unit 115 displays the keyword prompt screen 60, thereby prompting the user to change the keyword (S25).

Next, as shown in FIG. 7, when the process has switched to the document edit processing, the document display unit 120 displays the document edit screen on the display unit 24 (S29), when the edit acceptance unit 122 accepts an edit instruction (YES at S31), and the edited document is stored into the document temporary storage unit 108 (S33). On the other hand, when the edit acceptance unit 122 does not accept any edit instruction (NO at S31), the process bypasses step S33.

Subsequently, when the registration acceptance unit 124 accepts a request to register the edited document (YES at S35), the document stored in the document temporary storage unit 108 and the keyword stored in the keyword temporary storage unit 106 are registered in a condition where they are correlated to each other and are stored in the database DB2 as a document B and a keyword B respectively (S37). On the other hand, when the registration acceptance unit 124 does not accept the document registration request (NO at S35), the process returns to step S29.

As described above, according to the present embodiment of the information management apparatus 100, in copying of the document information in the database, the keyword is copied together with, also, a request is made to update the copied keyword, thereby enabling increasing significance of the keyword and improving efficiency in keyword search as compared to a case where the keyword of the copied document is registered as it is.

That is, the present embodiment solves a problem that if keywords are registered as they are without being updated, in a case where the document is copied repeatedly, an inappropriate keyword that does not match the reality so that necessary information may not be found in keyword search.

### Second Embodiment

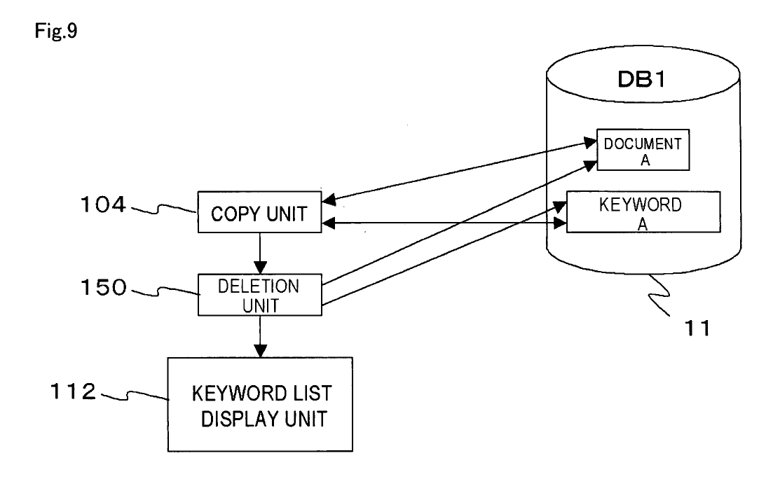

FIG. 9 is a functional block diagram showing a configuration of a main part of elements of an embodiment of the information management apparatus 100 according to the present invention. The present embodiment of the information management apparatus 100 is different from that of the above-described embodiment in that a deletion unit 150 is provided and a document in a database is moved into another database.

The deletion unit 150 deletes a document copied by a copy unit 104 and a keyword of the document from the database DB1.

When moving document information, the present embodiment of the information management apparatus 100 can add and change a keyword before movement to attach a different keyword to the document information after movement, thereby attaching a more appropriate keyword and improving efficiency in search.

### Third Embodiment

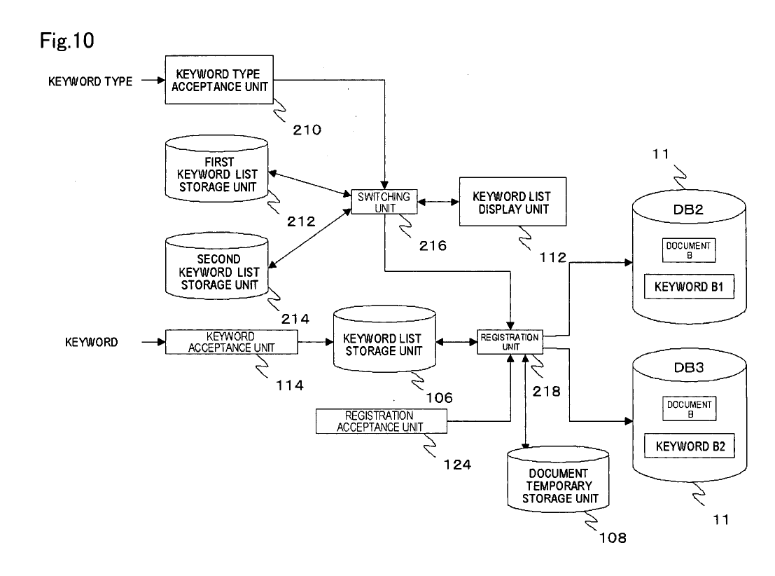

FIG. 10 is a functional block diagram showing a configuration of a main part of elements of an embodiment of the information management apparatus 100 according to the present invention.

The present embodiment of the information management apparatus 100 is described with reference to an example of attaching different keywords in order to manage document information such as a pre-accident situation report and distinguish field document information and manager document information for example.

The information management apparatus 100 is different from those of the above-described embodiments in that it includes a keyword type acceptance unit 210, a first keyword list storage unit 212, a second keyword list storage unit 214, and a switching unit 216, to enable designating a keyword by using a keyword group that is appropriate to a database into which a document is to be registered.

That is, the present embodiment of the information management apparatus 100 prepares different keyword lists for respective databases 11, to select a keyword from the keyword list appropriate to one of the databases 11 as a copy destination and register it into it. It is here supposed that a database DB2 is the database 11 into which a field document is to be stored and a database DB3 is the database 11 into which a manager document is to be stored.

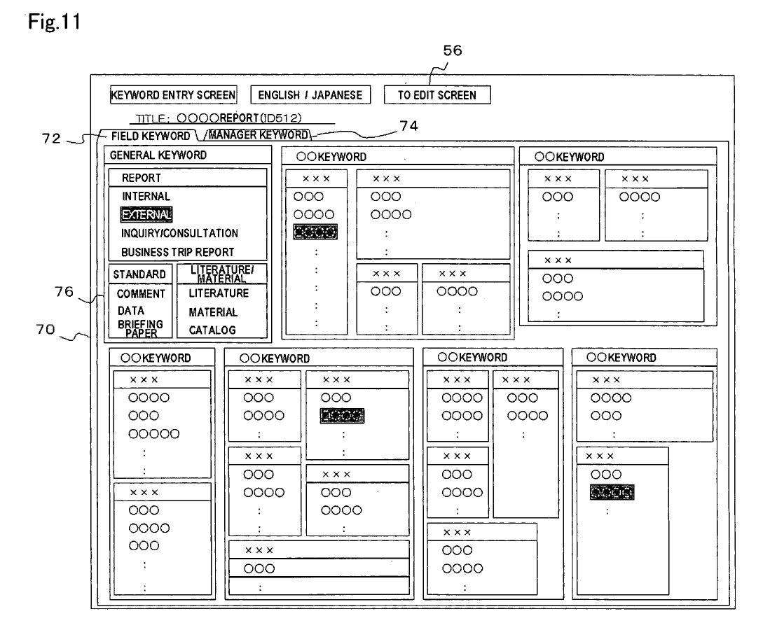

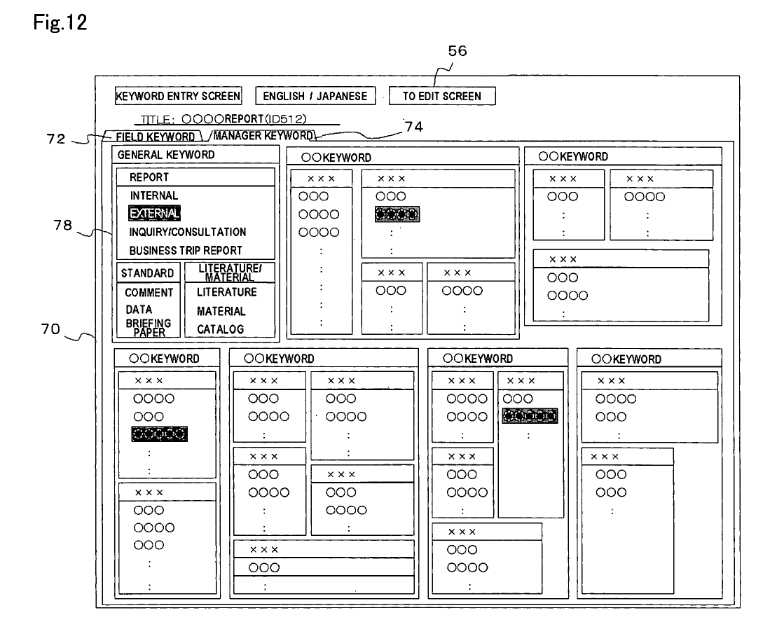

In the present embodiment of the information management apparatus 100, for example, the keyword list display unit 112 displays a keyword entry screen 70 shown in FIG. 11 on the display unit 24. The keyword entry screen 70 contains, for example, a plurality of tabs such as a field tab 72 and a manager tab 74, so that when the field tab 72 is selected, a field keyword list 76 is displayed, and when the manager tab 74 is selected, a manager keyword list 78 on the keyword entry screen 70 of FIG. 12 is displayed.

Referring back to FIG. 10, the keyword type acceptance unit 210 accepts a type of the keyword entry screen 70 to be displayed on the keyword list display unit 112. That is, it accepts an instruction on whether to display a first keyword list (field keyword list 76) or a second keyword list (manager keyword list 78) on the keyword entry screen 70 of the keyword list display unit 112. Specifically, it accepts a selection of the field tab 72 or the manager tab 74 of the keyword entry screen 70.

The first keyword list storage unit 212 and the second keyword list storage unit 214 store the first keyword list and the second keyword list respectively. In the present embodiment, the first keyword list storage unit 212 stores a list of keywords which are used to display the field keyword list 76 of the keyword entry screen 70 and the second keyword list storage unit 214 stores a list of keywords which are used to display the field keyword list 78 of the keyword entry screen 70.

When the keyword type acceptance unit 210 accepts a selection of the field tab 72 or the manager tab 74 of the keyword entry screen 70, the switching unit 216 switches to the corresponding keyword list and displays it on the keyword list display unit 112. The registration unit 218 registers and stores keywords, which was accepted by the keyword acceptance unit 114 and stored into the keyword temporary storage unit 106, into the database 11 that corresponds to the keyword type accepted by the keyword type acceptance unit 210 in a condition where they are correlated to the document.

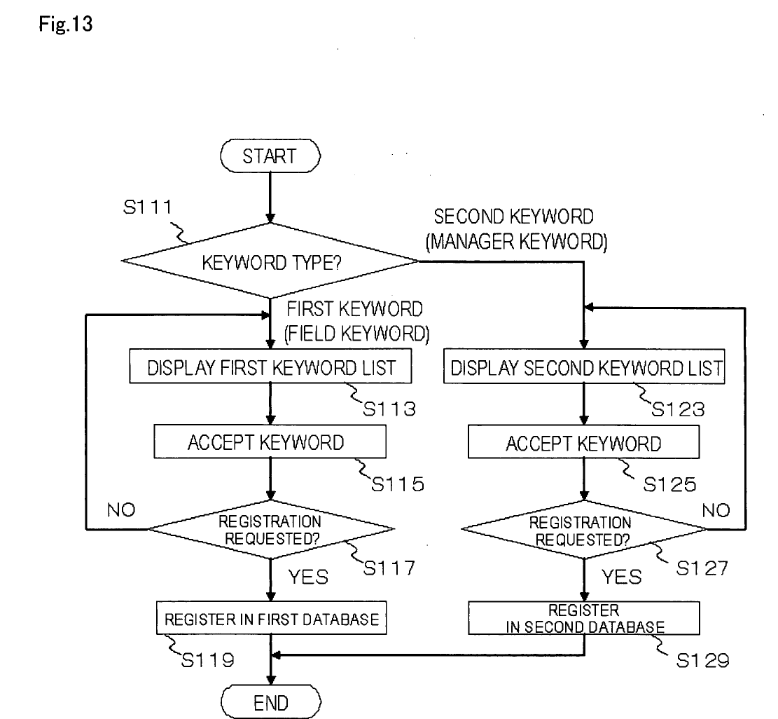

Operations of the information management apparatus 100 thus configured will be described below. FIG. 13 is a flowchart showing one example of the operations of the present embodiment of the information management apparatus 100.

First, the keyword type acceptance unit 210 accepts a keyword type (S111). When the keyword type accepted by the keyword type acceptance unit 210 is of a field (first keyword at S111), a field keyword list is read out from the first keyword list storage unit 212 and displayed as the field keyword list 76 on the keyword entry screen 70 of FIG. 11 (S113).

Subsequently, the keyword acceptance unit 114 accepts a keyword from the field keyword list 76 on the keyword entry screen 70 and stores it into the keyword temporary storage unit 106 (S115). Then, after the document is edited, for example, when an instruction to register the document in the database 11 is accepted by the registration acceptance unit 124 (YES at S117), the document B and its keyword B1 are registered and stored into the first database (database DB2) in a condition where they are correlated to each other (S119).

On the other hand, when the registration instruction is not accepted at S117 (NO at S117), the process returns to S113.

Further, when the keyword type accepted by the keyword type acceptance unit 210 is of a manager (second keyword at S111), a manager keyword list is read out from the second keyword list storage unit 214 and is displayed as the manager keyword list 78 on the keyword entry screen 70 of FIG. 12 (S123).

Subsequently, the keyword acceptance unit 114 accepts a keyword from the manager keyword list 78 on the keyword entry screen 70 and stores it into the keyword temporary storage unit 106 (S125). Then, after the document is edited, for example, when an instruction to register the document in the database 11 is accepted by the registration acceptance unit 124 (YES at S127), the document B and its keyword B2 are registered and stored into the second database (database DB3) in a condition where they are correlated to each other (S129). On the other hand, when the registration acceptance unit 124 does not accept the registration instruction (NO at S127), the process returns to S123.

As described above, in the present embodiment of the information management apparatus 100, an appropriate keyword option list can be selected from among the various keyword option lists to attach a keyword to document information, to attach a keyword appropriate to the database 11 in which the document information is to be saved.

### Fourth Embodiment

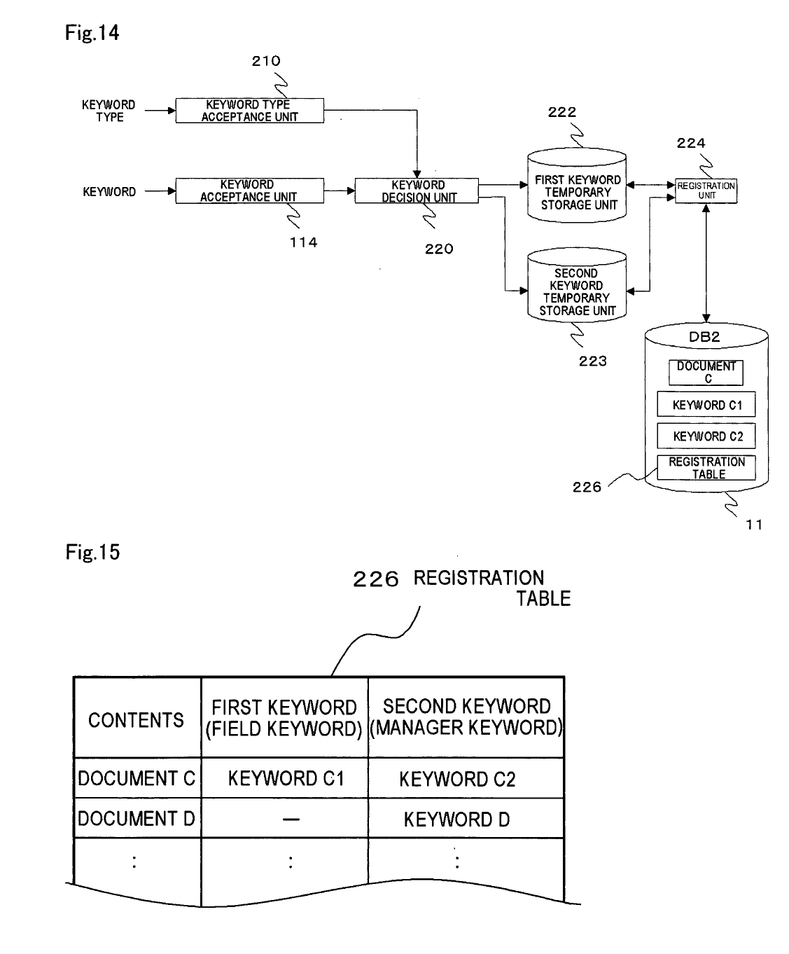

FIG. 14 is a functional block diagram showing a configuration of a main part of elements of an embodiment of the information management apparatus 100 according to the present invention. The present embodiment of the information management apparatus 100 is different from that of the above-described embodiment shown in FIG. 10 in that a keyword decision unit 220 is provided, a first keyword temporary storage unit 222 and a second keyword temporary storage unit 223 are provided in place of the keyword temporary storage unit 106, and a registration unit 224 is provided in place of the registration unit 218.

The keyword decision unit 220 decides into which one of the first keyword temporary storage unit 222 and the second keyword temporary storage unit 223 a keyword accepted by the keyword acceptance unit 114 should be stored, based on a keyword type accepted by the keyword type acceptance unit 210. For example, when the keyword type acceptance unit 210 accepts an instruction to display a first keyword list, that is, the field keyword list 76, a switching unit 216 shown in FIG. 10 is used to display the field keyword list 76 on the keyword entry screen 70 of the keyword list display unit 112. On the other hand, when the keyword type acceptance unit 210 accepts an instruction to display a second keyword list, that is, the manager keyword list 78, the switching unit 216 shown in FIG. 10 is used to display the manager keyword list 78 on the keyword entry screen 70 of the keyword list display unit 112.

The first keyword temporary storage unit 222 temporarily stores a first keyword, that is, the keyword accepted as a field keyword from the keyword decision unit 220. The second keyword temporary storage unit 223 temporarily stores a second keyword, that is, the keyword accepted as a manager keyword from the keyword decision unit 220.

The registration unit 224 registers the keywords stored in the first keyword temporary storage unit 222 and the second keyword temporary storage unit 223 into a registration table 226 in a condition where they are correlated to the document information and stores the document information, the first and second keywords, and the registration table 226 into the database 11.

FIG. 15 shows a structure of the registration table 226 of the present embodiment of the information management apparatus. In the registration table 226, content information, the first keyword, and the second keyword are registered in a condition where they are correlated to each other. It is to be noted that in the registration table 226, identifiers of a first keyword group and identifiers of a second keyword group are stored, and entities of the keywords are separately stored in the database 11 as first and second keywords.

In the information management apparatus 100 thus configured above, keywords attached based on a plurality of keyword lists can be registered in a condition where they are correlated to document information, so that in the case of searching the database 11 for the document information stored in it based on the various keyword lists, this information can be searched for in accordance with the keywords which are attached on the basis of the respective appropriate keyword lists, thereby improving efficiency in search. Further, for example, keywords attached from various perspectives can be registered separately in a condition where they are correlated to one piece of document information and so can be searched for from the different perspectives, thereby improving usability.

### Fifth Embodiment

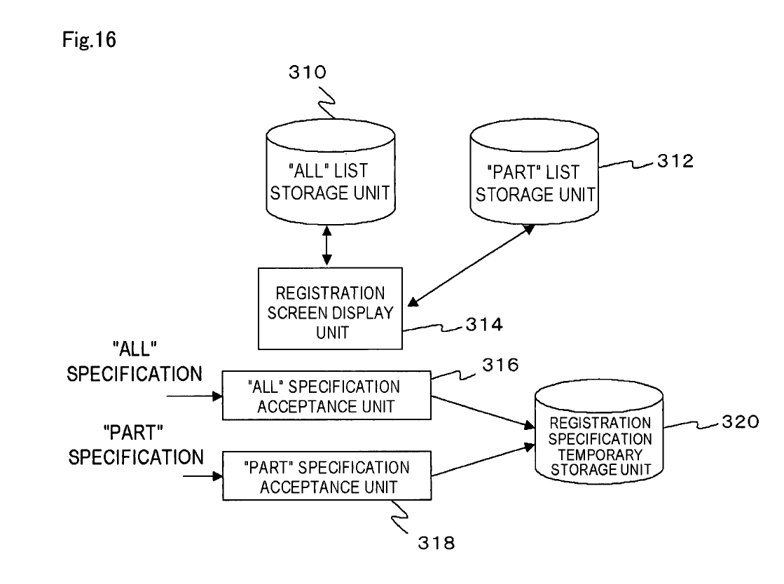

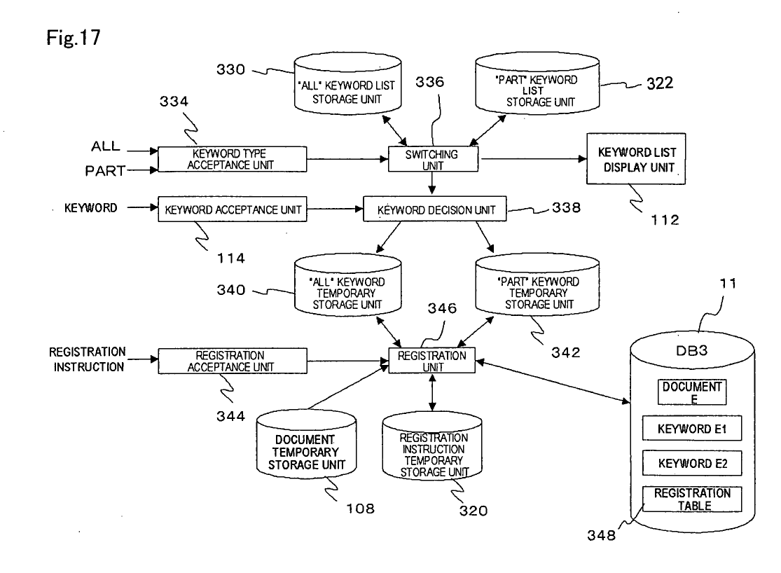

FIGS. 16 and 17 are functional block diagrams showing a configuration of a main part of elements of an embodiment of the information management apparatus 100 of the present invention.

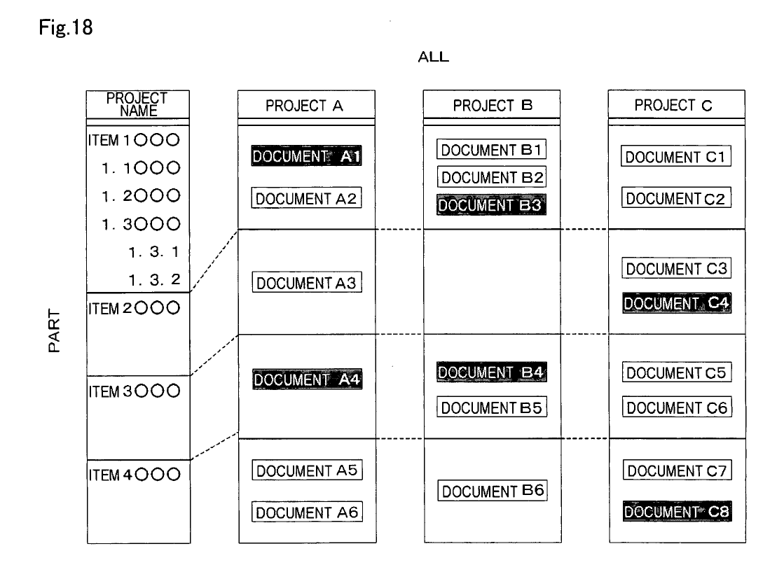

According to the present embodiment of the information management apparatus 100, two different attributes of first and second ones, for example, a plurality of units classified in terms of aproject name, a client name, and a document name and, for example, a plurality of items classified in terms of a process name, an item name, and a chapter (table of contents) may be specified when storing document information in the database 11. For example, as shown in FIG. 18, for each project, a plurality of documents are stored in the respective items. In the present embodiment, it is supposed that a classification of project names is referred to as “ALL” and a classification of item names is referred to as “PART”.

Referring back to FIG. 16, the present embodiment of the information management apparatus 100 is different from that of the above-described embodiments in that it is provided with an ALL list storage unit 310, a PART list storage unit 312, a registration screen display unit 314, an ALL specification acceptance unit 316, a PART specification acceptance unit 318, and a registration specification temporary storage unit 320.

The ALL list storage unit 310 stores an ALL list that has a plurality of unit names to which the document information to be stored in the database 11 belongs, for example, project names. The PART list storage unit 312 stores a PART list that has a plurality of item names to which the document information to be stored in the database 11 belongs.

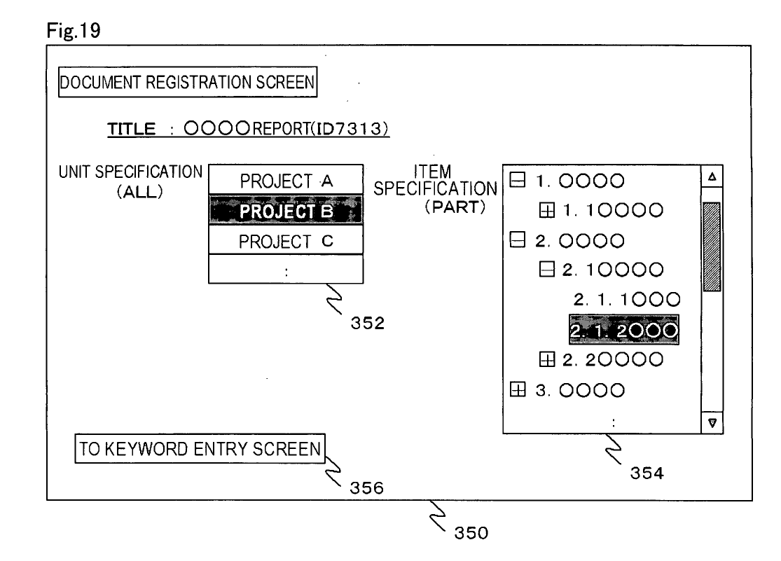

The registration screen display unit 314 hierarchically displays ALL lists and PART lists stored in the ALL list storage unit 310 and the PART list storage unit 312 respectively. FIG. 19 shows one example of a document registration screen 350 of the present embodiment of the information management apparatus 300. The document registration screen 350 contains an ALL specification field 352, a PART specification field 354, and a keyword entry screen button 356.

In the ALL specification field 352, a list of a plurality of unit names stored in the ALL list storage unit 310 is displayed, so that the user can perform ALL specification by moving a pointer to the ALL specification field 352 and clicking a mouse on it. The specified unit names are displayed in reverse. In the PART specification field 354, a list of a plurality of item names stored in the PART list storage unit 312 is displayed, so that the user can perform PART specification by moving the pointer the PART specification field 354 and clicking the mouse on it. The specified item name is displayed in reverse. The item names may be specified to lower level in the PART specification field 354. The keyword entry screen button 356 is an operation button used to switch to the keyword entry screen 50.

Referring back to FIG. 16, the ALL specification acceptance unit 316 accepts a specification of the unit name to which document information to be registered desirably corresponds. Hereinafter, this specification is referred to as “ALL specification”. The PART specification acceptance unit 318 accepts a specification of the item name to which document information to be registered desirably corresponds. Hereinafter, this specification is referred to as “PART specification”.

The registration specification temporary storage unit 320 temporarily stores a specification accepted by the ALL specification acceptance unit 316 and a specification accepted by the PART specification acceptance unit 318 as registration specification information. It is to be noted that the registration specification information refers to information that indicates the first and second attributes of the document information, that is, information that indicates to which item of which unit, the document information corresponds.

As shown in FIG. 17, the present embodiment of the information management apparatus 100 is different from that of the above-described embodiment of FIG. 3 in that an ALL keyword list storage unit 330 and a PART keyword list storage unit 332 are provided in place of the keyword list storage unit 110, an ALL keyword list temporary storage unit 340 and a PART keyword temporary storage unit 342 are provided in place of the keyword temporary storage unit 106, a registration acceptance unit 344 and a registration unit 346 are provided in place of the registration acceptance unit 124 and the registration unit 126 respectively, and a keyword type acceptance unit 334, a switching unit 336, and a keyword decision unit 338 are provided.

The ALL keyword list storage unit 330 stores a first keyword list to be displayed on the keyword list display unit 112 when ALL specification is performed. The PART keyword list storage unit 332 stores a second keyword list to be displayed on the keyword list display unit 112 when PART specification is performed.

The keyword type acceptance unit 334 accepts an instruction on which one of a keyword list of first keywords (for ALL) and a keyword list of second keywords (for PART) should be displayed on the keyword list display unit 112. Specifically, similar to the above-described embodiment of FIG. 11, it is specified by selecting either an ALL tab (not shown) or a PART tab (not shown) which are provided on a keyword entry screen 70.

The switching unit 336 switches a keyword list to be displayed on the keyword list display unit 112 in accordance with a keyword type, ALL or PART, accepted by the keyword type acceptance unit 334.

The keyword decision unit 338 decides in which one of the ALL keyword temporary storage unit 340 and the PART keyword temporary storage unit 342 a keyword accepted by the keyword acceptance unit 114 should be stored, in accordance with a keyword type accepted by the keyword type acceptance unit 334. For example, when the keyword type acceptance unit 334 accepts an instruction to display a keyword list for ALL, the switching unit 336 serves to display the keyword list for ALL on the keyword entry screen 70 of the keyword list display unit 112. On the other hand, when the keyword type acceptance unit 334 accepts an instruction to display a keyword list for PART, the switching unit 336 serves to display the keyword list for PART on the keyword entry screen 70 of the keyword list display unit 112.

The ALL keyword temporary storage unit 340 temporarily stores a keyword accepted as a keyword for ALL from the keyword decision unit 338. The PART keyword temporary storage unit 342 temporarily, stores a keyword accepted as a keyword for PART from the keyword decision unit 338.

The registration acceptance unit 344 accepts a registration instruction to register a document into the database 11. The registration instruction contains a specification of a database, a folder, and a file name as a copy destination to which the copied document is to be stored.

The registration unit 346 creates a registration table 348 in accordance with registration specification information temporarily stored in the registration specification temporary storage unit 320, a keyword for ALL stored in the ALL keyword temporary storage unit 340, and a keyword for PART stored in the PART keyword temporary storage unit 342. The registration unit 346 further stores the document information, the keyword for ALL, the keyword for PART, and the registration table 348 into the copy-destination database 11 accepted by the registration acceptance unit 344, in a condition where they are correlated to each other. It is to be noted that identifiers of a keyword group for ALL and those of a keyword group for PART are stored in the registration table 348, and entities of the keywords are separately stored in the database 11 as keywords for ALL and keywords for PART.

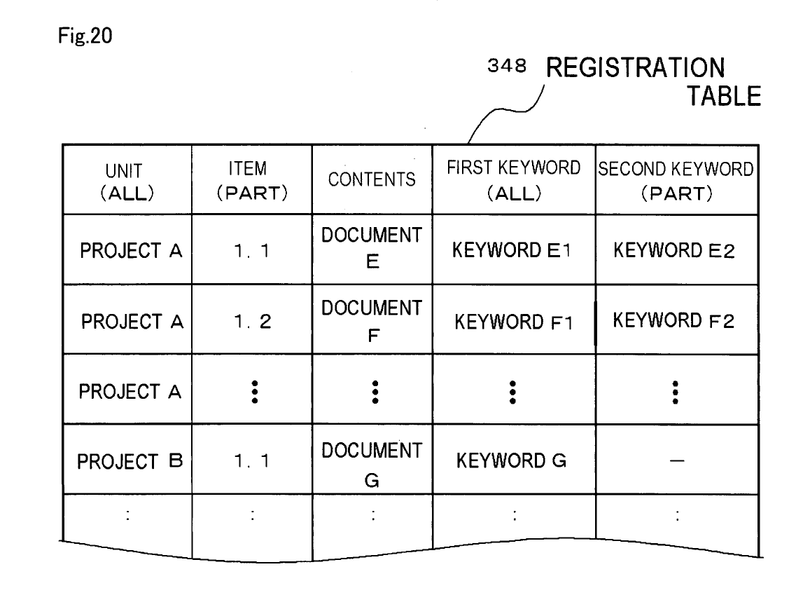

FIG. 20 shows a structure of the registration table 348 of the present embodiment. In the registration table 348, content information, keywords for ALL, and keywords for PART are registered for each item of each unit in a condition where they are correlated to each other.

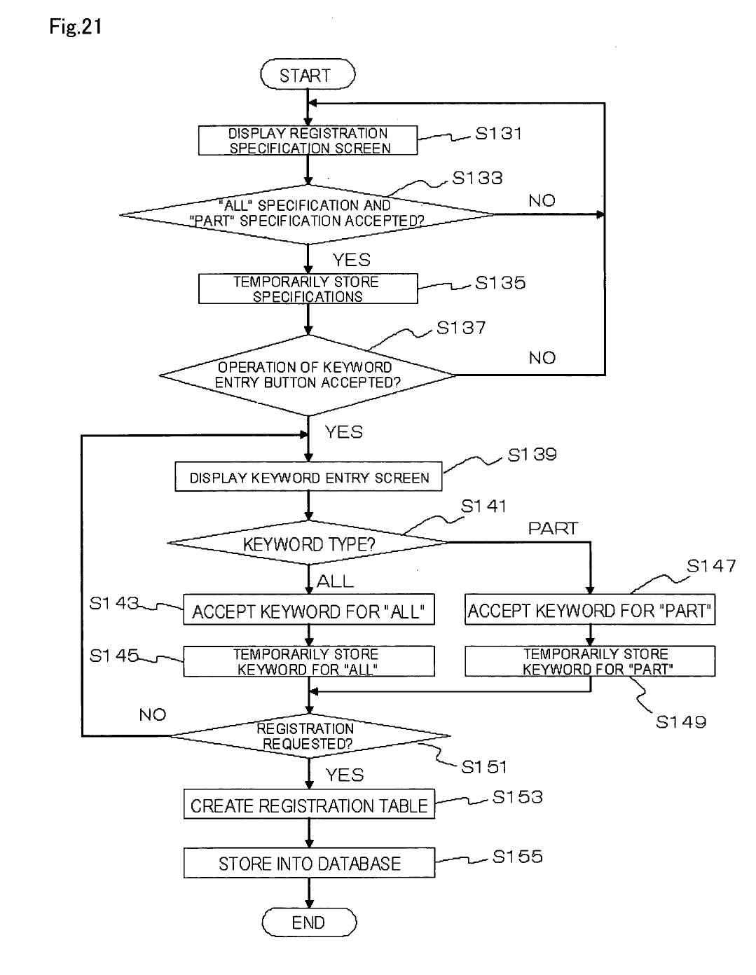

Operations of the thus configured information management apparatus 300 are described blow. FIG. 21 is a flowchart showing one example of the operations of the present embodiment of the information management apparatus 300.

When a document is copied or moved, first the document registration screen 350 shown in FIG. 19 is displayed on the registration screen display unit 314 (S131). Subsequently, when the ALL specification acceptance unit 316 and the PART specification acceptance unit 318 accept an ALL specification and a PART specification respectively (YES at S133), the accepted specifications are stored into the registration specification temporary storage unit 320 (S135). At this time, on the document registration screen 350, the specified unit and item are each displayed in reverse as shown in FIG. 19.

Subsequently, when the operation unit 26 accepts an operation of the keyword entry screen button 356 (YES at S137), the keyword entry screen is displayed on the keyword list display unit 112 (S139). It is to be noted that when an instruction and an operation are not accepted at steps S133 and S137 respectively (NO at S133 and S137), the process returns to step S131.

After the keyword entry screen is displayed on the keyword list display unit 112, the keyword type acceptance unit 334 accepts a keyword type (S141). When the keyword type acceptance unit 334 accepts an ALL specification (ALL at S141), the keyword decision unit 338 accepts the keyword accepted by the keyword acceptance unit 114 as a keyword for ALL (S143) and temporarily stores it in the ALL keyword temporary storage unit 340 (S145).

On the other hand, when the keyword type acceptance unit 334 accepts a PART specification (PART at S141), the keyword decision unit 338 accepts the keyword accepted by the keyword acceptance unit 114 as a keyword for PART (S147) and temporarily stores it in the PART keyword temporary storage unit 342 (S149).

Subsequently, when the registration acceptance unit 344 accepts a registration instruction (YES at S151), the registration unit 346 creates the registration table 348 in accordance with the registration specification information temporarily stored in the registration specification temporary storage unit 320 at step S135 and the keywords for ALL and keywords for PART stored in the ALL keyword temporary storage unit 340 and the PART keyword temporary storage unit 342 respectively (S153).

Subsequently, the registration unit 346 stores the document information, the keyword for ALL, the keyword for PART, and the registration table 348 into the database 11, which is accepted by the registration acceptance unit 344 as copy destination, in a condition where they are correlated to each other (S155). It is to be noted that when the registration instruction is not accepted at step S151 (NO at S151), the process returns to step S139.

As described above, in the present embodiment of the information management apparatus 300, the document information can be registered being classified in terms of units, items and the like, and in registration of the document information, a keyword for the unit and a keyword for the item can be attached to the document information, so that the document information can be searched for using various keyword lists from various perspectives, thereby improving search efficiency.

### Sixth Embodiment

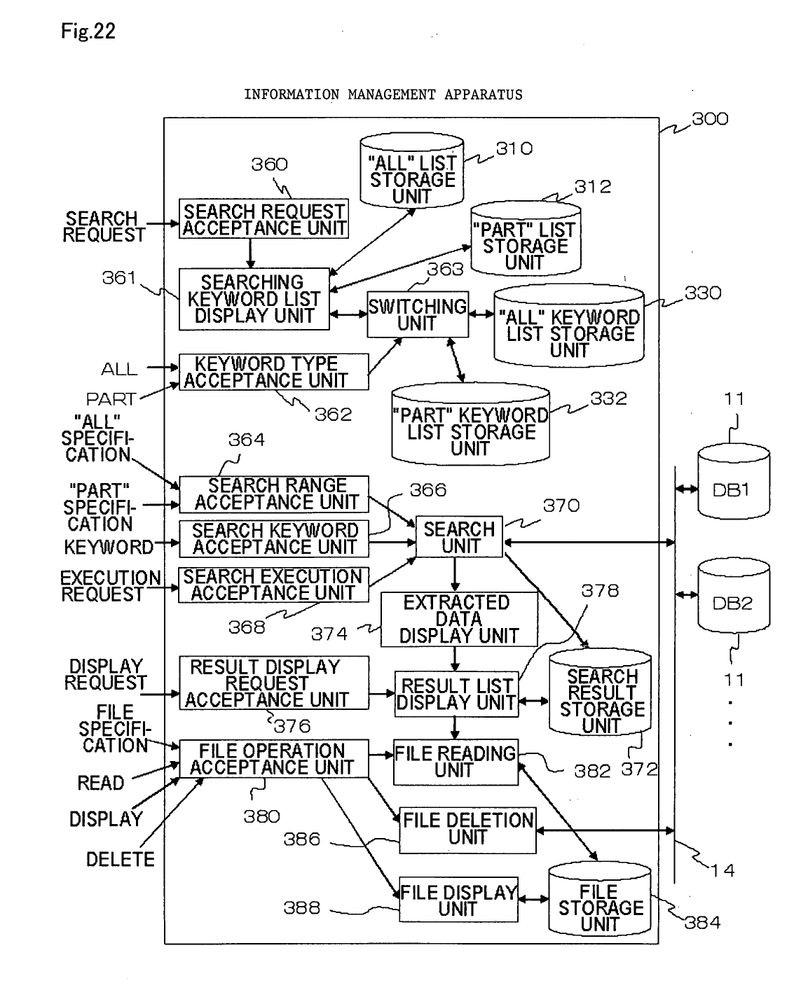

FIG. 22 is a functional block diagram showing a configuration of a main part of elements of an embodiment of the information management apparatus according to the present invention. The present embodiment of the information management apparatus 300 is capable of keyword search with All specification and PART specification in the above-described embodiment of the information management apparatus shown in FIGS. 16 and 17.

The information management apparatus 300 includes, in addition to the elements of the information management apparatus of FIGS. 16 and 17, a search request acceptance unit 360, a searching keyword list display unit 361, a keyword type acceptance unit 362, a switching unit 363, a search range acceptance unit 364, a search keyword acceptance unit 366, a search execution acceptance unit 368, a search unit 370, a search result storage unit 372, an extracted data display unit 374, a result display request acceptance unit 376, a result list display unit 378, a file operation acceptance unit 380, a file reading unit 382, a file storage unit 384, a file deletion unit 386, and a file display unit 388.

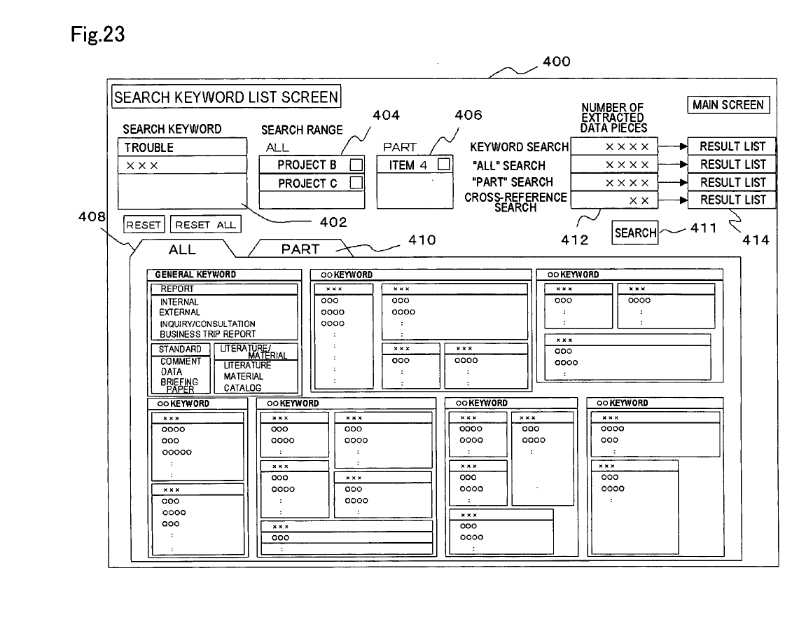

In the information management apparatus 300, the search request acceptance unit 360 accepts a request to search for document information from the operation unit 26. The searching keyword list display unit 361 displays a search keyword specification screen 400 shown in FIG. 23.

The search keyword specification screen 400 contains a search keyword field 402, an ALL specification field 404, a PART specification field 406, an ALL specification tab 408, a PART specification tab 410, a search button 411, a number-of-extracted-data-pieces display field 412, and a result list button 414.

In the search keyword field 402, a keyword selected from a keyword list is displayed. The ALL specification field 404 and the PART specification field 406 are used to specify a search range. It is possible to specify a plurality of search ranges and also possible not to specify search range. Further, in the PART specification field 406, items to lower level may be specified. By moving a pointer to the ALL specification field 404 and clicking a mouse on it, an ALL list stored in the ALL list storage unit 310 is displayed, and from which, a unit subjected to ALL specification may be selected. Further, by moving the pointer to the PART specification field 406 and clicking the mouse on it, a PART list stored in the PART list storage unit 312 is displayed, from which, a unit subjected to PART specification may be selected.

A keyword list for ALL is displayed when the ALL specification tab 408 is selected, and a keyword list for PART is displayed when the PART specification tab 410 is selected. The search button 411 is an operation button which is used to search for document information included in a search range specified by the ALL specification field 404 and the PART specification field 406 by using a keyword specified in the search keyword field 402.

In the number-of-extracted-data-pieces display field 412, the number of data pieces extracted as a result of search is displayed for each search. The result list button 414 is an operation button which is used to display a list of search results for each search. That is, when an operation of the result list button 414, which is arranged next to the number-of-extracted-data-pieces display field 412 for keyword search, is accepted, a list of results of search for a keyword without a search range specified is displayed. Further, when an operation of the result list button 414, which is arranged next to the number-of-extracted-data-pieces display field 412 for ALL search, is accepted, a list of results of search for a keyword in a search range specified in ALL specification is displayed. When an operation of the result list button 414, which is arranged next to the number-of-extracted-data-pieces display field 412 for PART search, is accepted, a list of results of search for a keyword in a search range specified in PART specification is displayed. Further, when an operation of the result list button 414, which is arranged next to the number-of-extracted-data-pieces display field 412 for cross-reference search, is accepted, a list of results of search for a keyword in a search range specified both in ALL specification and PART specification is displayed.

In such a manner, a list of search results can be displayed for each specified range, allowing search for information from various perspectives, thereby improving usability.

Referring back to FIG. 22, the keyword type acceptance unit 362 accepts a type of a keyword list to be displayed on the searching keyword list display unit 361. That is, it accepts an instruction on which one of a keyword list for ALL and a keyword list for PART should be displayed on the search keyword specification screen 400 of the searching keyword list display unit 361. Specifically, it accepts a selection of the ALL specification tab 408 or the PART specification tab 410 on the search keyword specification screen 400 of FIG. 23.

When the keyword type acceptance unit 362 accepts a selection of the ALL specification tab 408 or the PART specification tab 410 on the search keyword specification screen 400 of FIG. 23, the switching unit 363 reads the corresponding keyword list from the ALL keyword list storage unit 330 or the PART keyword list storage unit 332 and performs switching, and displays the keyword list on the searching keyword display unit 361. The search range acceptance unit 364 accepts specifications of the ALL specification field 404 and the PART specification field 406 on the search keyword specification screen 400 of FIG. 23 in order to determine document information to be searched for.

The search keyword acceptance unit 366 accepts a keyword selected from the keyword list on the search keyword specification screen 400 of FIG. 23. The keyword accepted by the search keyword acceptance unit 366 is displayed in the search keyword field 402 on the search keyword specification screen 400 of FIG. 23. The search execution acceptance unit 368 accepts an operation of the search button 411 on the search keyword specification screen 400 of FIG. 23 as a search execution request.

When the search execution acceptance unit 368 accepts the search execution request, the search unit 370 searches for document information that corresponds to the keyword accepted by the search keyword acceptance unit 366 from document information having ALL specification and PART specification accepted by the search range acceptance unit 364 as a search target from the database 11 corresponding to the search target.

The search result storage unit 372 stores results of search executed by the search unit 370. The extracted data display unit 374 displays the number of data pieces extracted as a result of search by the search unit 370 in the number-of-extracted-data-pieces display filed 412 on the search keyword specification screen 400 of FIG. 23.

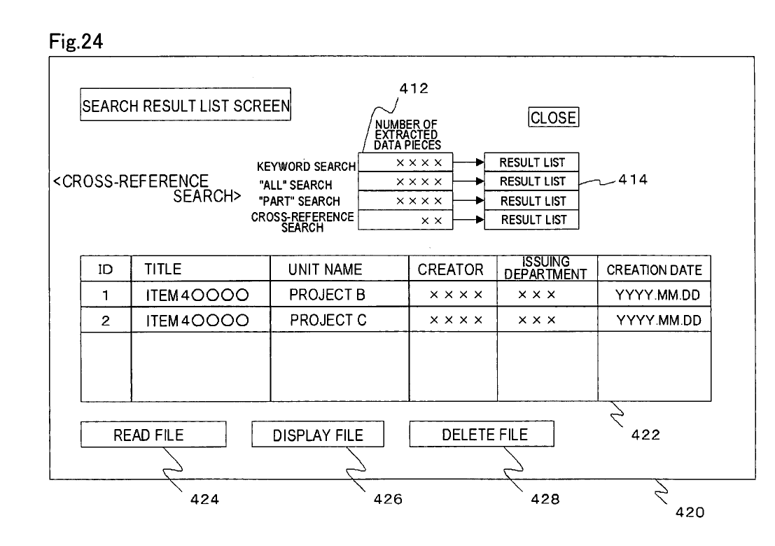

The result display request acceptance unit 376 accepts an operation of the result list button 414 on the search keyword specification screen 400 of FIG. 23. When the result display request acceptance unit 376 accepts an operation of the result list button 414, the result list display unit 378 displays a list of results of the corresponding search. FIG. 24 shows one example of a search result list display screen 420. The search result list display screen 420 contains the number-of-extracted-data-pieces display field 412, the result list button 414, a search result field 422, a reading button 424, a display button 426, and a deletion button 428.

In the search result field 422, search results are displayed in a list. For example, the list of results contains a title name of the document information, a name of a unit to which the document information belongs, a creator of the document information, a name of a department that has issued it, a creation date and the like.

The reading button 424 is an operation button which is used to accept an instruction to read the document information selected from the search result list from the database 11 and save it. The display button 426 is an operation button which is used to accept an instruction to read the document information selected from the search result list from the database 11 and display it. The deletion button 428 is an operation button which is used to accept an instruction to delete the document information selected from the search result list from the database 11.

Referring back to FIG. 22, the file operation acceptance unit 380 accepts a file of the document information specified in the search result field 422 of the PART specification tab 410 of FIG. 24. The file operation acceptance unit 380 further accepts the respective operations of the reading button 424, the display button 426, and the deletion button 428 on the research result list screen 420 of FIG. 24.

When the file operation acceptance unit 380 accepts an operation of the reading button 424, the file reading unit 382 reads the file accepted by the file operation acceptance unit 380 from the database 11 via a network 14 and stores it in the file storage unit 384. The file storage unit 384 stores the file read from the database 11.

When the file operation acceptance unit 380 accepts an operation of the deletion button 428, the file deletion unit 386 deletes the file accepted by the file operation acceptance unit 380 from the database 11 via the network 14. When the file operation acceptance unit 380 accepts an operation of the display button 426, the file display unit 388 reads the file accepted by the file operation acceptance unit 380 from the database 11 via the network 14 and stores it in the file storage unit 384 and displays it on the display unit 24.

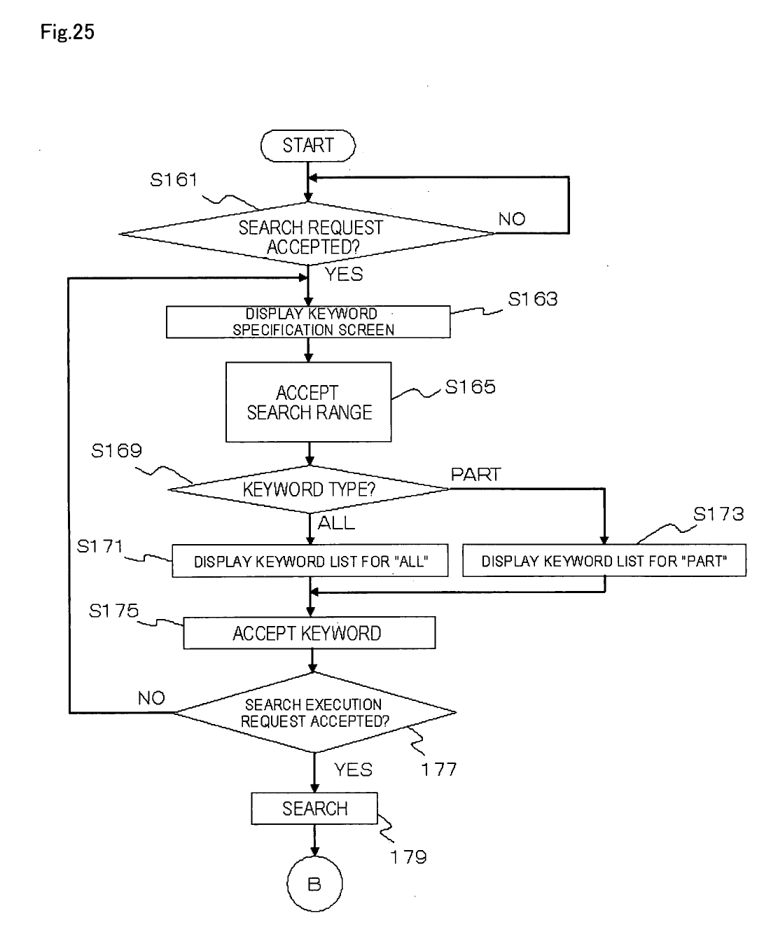

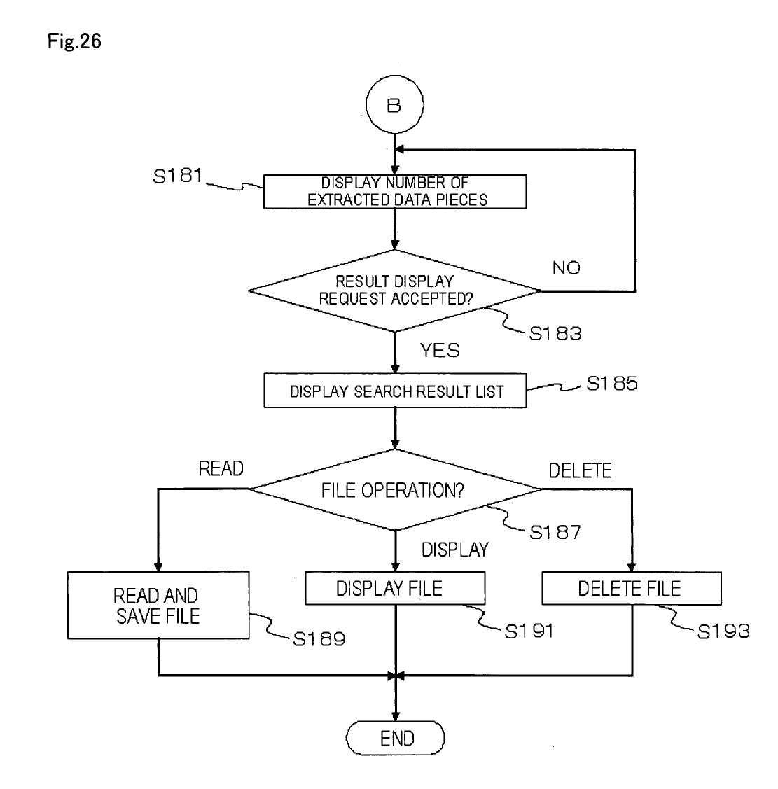

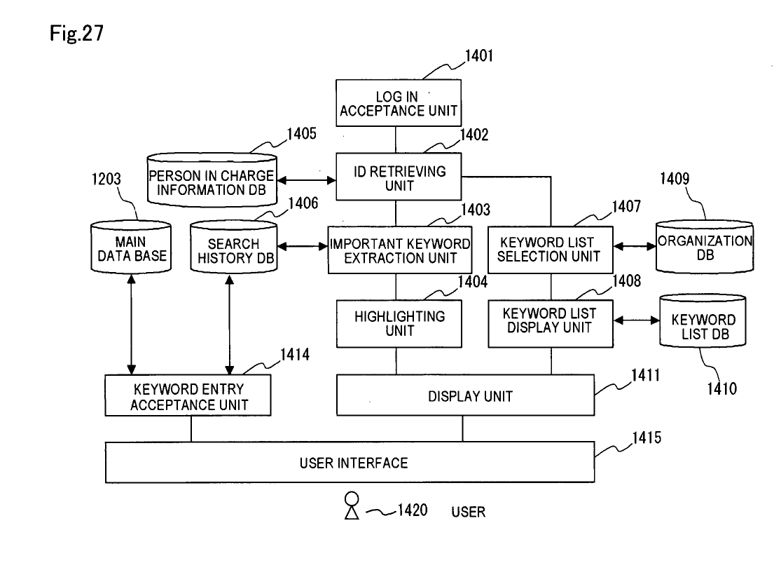

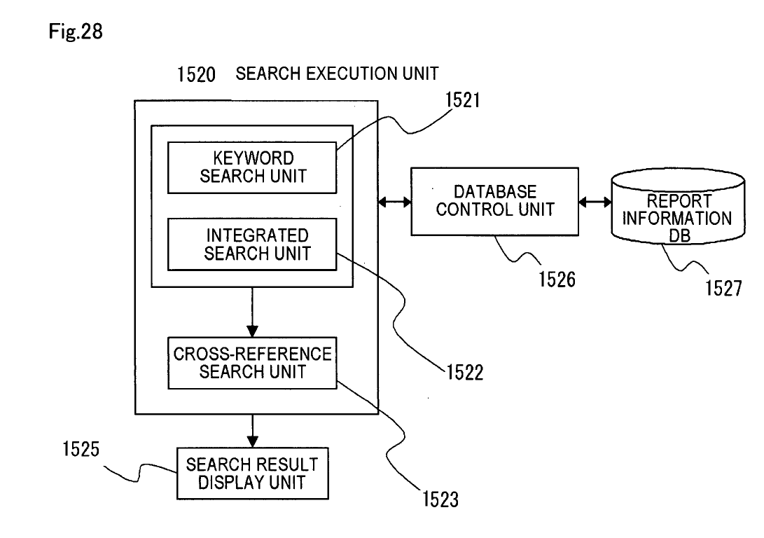

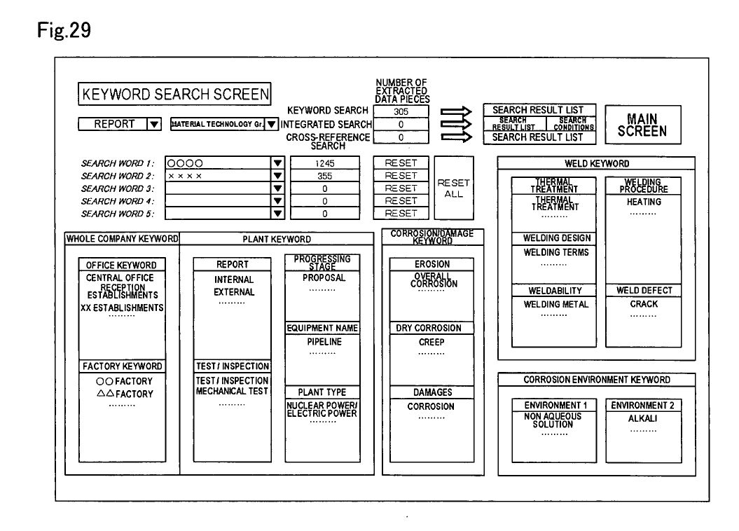

Operations of the thus configured information management apparatus 300 will be described below. FIGS. 25 and 26 are flowcharts showing one example of the operations of the present embodiment of the information management apparatus 300.

First, when the search request acceptance unit 360 accepts a search request (YES at S161), the searching keyword list display unit 361 displays the search keyword specification screen 400 of FIG. 23 (S163). Subsequently, the search range acceptance unit 364 accepts an ALL specification and a PART specification in order to determine document information to be searched for (S165). It is to be noted that either one of an ALL specification and a PART specification or both of them may be accepted at this step. Alternatively, none of them may be accepted. Subsequently, the keyword type acceptance unit 362 accepts a keyword type (S169). When the keyword type acceptance unit 362 accepts an ALL specification (ALL at S169), the searching keyword list display unit 361 displays a list of keywords for ALL in a keyword list on the search keyword specification screen 400 (S171). On the other hand, when the keyword type acceptance unit 362 accepts a PART specification (PART at S169), the searching keyword list display unit 361 displays a list of keywords for PART in the keyword list on the search keyword specification screen 400 (S173).

Subsequently, the search keyword acceptance unit 366 accepts a keyword (S175). Subsequently, when the search execution acceptance unit 368 accepts a search execution request (YES at S177), the search unit 370 searches the database 11 via the network 14 for document information having the keyword accepted at step S175 in the search range specified at step S165 (S179).

The following will exemplify a case where a plurality of documents are stored being classified into a plurality of items for each of a plurality of units (projects A, B, and C) in the database 11 as shown in FIG. 18. In a case where the same keyword is attached to the document displayed in reverse in the drawings, for example, document information having an ALL specification and a PART specification accepted by the search range acceptance unit 364 at step S165 is determined as a search target, so that the search unit 370 extracts document information that corresponds to the keyword from the search target at step S179. Actually, even if the keyword is attached to the six documents as shown in the drawings, in a case where search target is specified such as, for example, “the projects A and B” is specified as ALL specification and “item 3” is specified as PART specification, two documents of the documents A4 and B4 are extracted by search. It is thus possible to specify search target, thereby improving search efficiency comparing to simple keyword search.

Next, as shown in FIG. 26, the extracted data display unit 374 displays the number of extracted data pieces in the number-of-extracted-data-pieces display field 412 on the search keyword specification screen 400 (S181). Although according to the present embodiment, the number of extracted data pieces is displayed for each search process, the present invention is not limited to it.

Subsequently, when the result display request acceptance unit 376 accepts a result list display request (YES at S183), the result list display unit 378 displays the search result list screen 420 (S185). Subsequently, the file operation acceptance unit 380 accepts a file operation instruction (S187). When the file operation acceptance unit 380 accepts a file reading instruction (READ at S187), the file reading unit 382 reads the file accepted via the network 14 by the file operation acceptance unit 380 from the database 11 via the network 14 and stores it in the file storage unit 384 (S189).

On the other hand, when the file operation acceptance unit 380 accepts a file display instruction (DISPLAY at S187), the file display unit 388 reads the file accepted by the file operation acceptance unit 380 from the database 11 via the network 14 and stores it in the file storage unit 384 and displays it on the display unit 24 (S191). Further, when the file operation acceptance unit 380 accepts a file deletion instruction (DELETE at S187), the file deletion unit 386 deletes the file accepted by the file operation acceptance unit 380 from the database 11 via the network 14 (S193).

As described above, according to the present embodiment of the information management apparatus 300, a keyword for ALL and a keyword for PART can be specified by using different keyword lists to specify a search range in search for a document, so that it is possible to search for a desired document from different perspectives, thereby improving search efficiency and usability as well.

Although the embodiments of the present invention have been described with reference to the drawings, these are examples of the present invention, and a variety of configurations other than the above can be employed.

For example, although in the above embodiments, the notification unit 115 prompts entry of a keyword by displaying a screen, the present invention is not limited to it; it is possible to prompt entry of a keyword by using an audio or alarm sound. Further, such a configuration may be employed that edit of a document is not permitted unless a keyword is added or changed.

Although in the above embodiments, entry of a keyword is prompted every time when a document has been copied, the present invention is not limited to it. For example, the information management apparatus of the present invention may include a decision unit that decides whether a keyword in the keyword temporary storage unit 106 has been changed or given an addition of another keyword when document information and a keyword have been copied by the copy unit 104 and a prohibition unit that prohibits the registration unit 126 from storing document information into the database 11 when the decision unit has decided that the keyword has not been changed or given an addition.

In this case, the decision unit can read a keyword copied from the database and stored into the storage unit and compare it to a keyword accepted by the keyword acceptance unit and, if they do not match, decide that the keyword has been changed. Alternatively, the comparison is performed by comparing character string codes or by comparing data sizes of the character strings of the keywords. Alternatively, in a case where a keyword in the storage unit has been stored in terms of an identification code that corresponds to a predetermined keyword list, the identification codes may be compared. Alternatively, the decision unit may monitor whether another keyword has been written into the storage unit after a keyword was copied from the database and, if such is the case, decide that the keyword has been changed.

With this configuration, it is possible to cause the user to add and change a keyword more certainly when the document information has been copied.

Further, in any of the other embodiments, it is possible, for example, to provide a creation unit that creates a archive file by joining a plurality of documents contained in each of the units of FIG. 18, store the thus created archive files into the database 11, and search for document information in the archive file that corresponds to the unit subjected to ALL specification.

1. An information management apparatus comprising:
a database, in which document information relating to documents and keywords which have been correlated to said document information in order to search for the document information are electronically saved;
a copying unit that copies the document information retrieved from said database and also copies said keywords at the same time;
a storage unit that temporarily stores said document information and said keywords copied by said copying unit;
a keyword acceptance unit that accepts entry of the keyword selected from a list of keyword options displayed on a keyword entry screen as a keyword to be correlated to said document information copied by said copying unit;
a notification unit that prompts entry of the keyword from the keyword option list displayed on said keyword entry screen when said document information and said keywords are copied by said copying unit; and
an information registration unit that stores said keywords in said storage unit into said database in a condition where they are correlated to the document information in said storage unit,
wherein said keywords in said storage unit are given an addition of or changed to said keyword accepted by said keyword acceptance unit.

2. The information management apparatus according to claim 1, comprising a keyword presentation unit that highlights a keyword correlated to said document information, on said keyword entry screen.

3. The information management apparatus according to claim 1, comprising:
a decision unit that decides whether said keyword is changed by accessing to said storage unit when said document information and said keyword are copied; and
a prohibition unit that prohibits said information registration unit from storing said document information into said database when said decision unit decided that said keyword was not changed.

4. The information management apparatus according to claim 1, comprising a deletion unit that deletes said document information and said keyword as copy source from said database after said document information and said keyword were copied by the copying unit.

5. The information management apparatus according to claim 1,
wherein said document information and said keyword copied by said copying unit are copied into a database different from the database as copy source.

6. The information management apparatus according to claim 2, comprising a keyword type acceptance unit that accepts switching between lists of pluralities of kinds of keyword options to be displayed on said keyword entry screen,
wherein said keyword presentation unit displays on said keyword entry screen a list of keyword options corresponding to a type accepted by said keyword type acceptance unit and displays a keyword correlated to said document information from among said options in highlight, and
said keyword acceptance unit accepts the keyword selected from said keyword option list displayed on said keyword entry screen.

7. The information management apparatus according to claim 6,
wherein said storage unit contains a plurality of keyword storage units that correspond to said plurality of kinds of keyword option lists, to respectively store keywords accepted by said keyword acceptance unit as keywords specific to types accepted by said keyword type acceptance unit in the keyword storage units that correspond to the keyword types, and
said information registration unit stores the keywords in said database corresponding to the types as keywords specific to the types accepted by said keyword type acceptance unit in a condition where the keywords are respectively correlated to said document information.

8. An information management apparatus comprising:
a database, in which document information relating to documents and keywords which have been correlated to said document information in order to search for said document information are electronically saved;
an attribute presentation unit that presents contents of two different attributes, first and second ones, to be attached to said document information in order to classify said document information;
an attribute acceptance unit that accepts said first and second attributes to be attached to said document information, based on said contents of said first and second attributes presented by said attribute presentation unit;
a keywords list storage unit that stores first and second keyword option lists that correspond to said first and second attributes respectively;
a list switching acceptance unit that accepts switching between said first and second keyword option lists to be displayed on a keyword entry screen;
a keyword acceptance unit that accepts, as a keyword to be correlated to said document information, entry of the keyword selected from the keyword option list displayed as a result of the switching on said keyword entry screen;
an information registration unit that stores said keyword accepted by said keyword acceptance unit and said first and second attributes accepted by said attribute acceptance unit into said database in a condition where they are correlated to said document information;
a target acceptance unit that accepts designation of said first and second attributes, in order to determine the document information to be a search target;
a search keyword acceptance unit that accepts keyword which is used in search, from said first and second keyword option lists respectively;
a search unit that extracts the document information that corresponds to said keyword by searching from said document information having said attributes accepted by said target acceptance unit as the search target; and
an information presentation unit that presents said document information searched by said search unit, separately in each of said first attributes or for each of said second attributes.

9. The information management apparatus according to claim 8, comprising:
a copying unit that copies document information from said database and copying said keyword at the same time; and
a notification unit that prompts entry of the keyword from said first or second keyword option list displayed on said keyword entry screen when said document information and said keyword have been copied by said copying unit.

10. An information management method for electronically saving, into a database, document information relating to documents and keywords which have been correlated to the document information in order to search for the document information and managing them, said method comprising:
copying the document information retrieved from said database and also copying said keywords at the same time;
temporarily storing said document information and said keywords which have been copied, into a storage unit;
accepting entry of the keyword selected from a list of keyword options displayed on a keyword entry screen as a keyword to be correlated to said copied document information;
prompting entry of the keyword from the keyword option list displayed on said keyword entry screen when said document information and said keywords are copied;
storing said keywords in said storage unit into the database in a condition where they are correlated to the document information in said storage unit; and
giving an addition of or changing said keywords in said storage unit to said keyword accepted by said keyword acceptance unit.

11. An information management method for managing a database which electronically saves therein document information relating to documents and keywords which have been correlated to said document information in order to search for said document information, said method comprising:
presenting contents of two different attributes, first and second ones, to be attached to said document information in order to classify said document information;
accepting said first and second attributes to be attached to said document information, based on said contents of said presented first and second attributes;
storing first and second keyword option lists that correspond to said first and second attributes respectively, into a keyword list storage unit;
accepting switching between said first and second keyword option lists to be displayed on a keyword entry screen;
accepting, as a keyword to be correlated to said document information, entry of the keyword selected from the keyword option list displayed as a result of the switching on said keyword entry screen;
storing said accepted keyword accepted and said first and second attributes accepted by said attribute acceptance unit into said database in a condition where they are correlated to said document information;
when searching said database for said document information saved in it, specifying said first and second attributes and accepting them as a search range;
accepting the keyword which is used in search, from said first and second keyword option lists respectively;
searching the document information saved in said search range for such document information as to correspond to said keyword; and
presenting said document information searched separately in each of said first attributes or for each of said second attributes.

12. An information management program for controlling an apparatus that electronically saves, into a database, document information relating to documents and keywords which have been correlated to the document information in order to search for the document information and manages them, said program causing this apparatus to perform:
copying the document information retrieved from said database and also copying said keywords at the same time;
temporarily storing said document information and said keywords which have been copied in said copying the document information, into a storage unit;
accepting entry of the keyword selected from a list of keyword options displayed on a keyword entry screen as a keyword to be correlated to said document information copied in said copying the document information;
prompting entry of the keyword from the keyword option list displayed on said keyword entry screen when said document information and said keywords have been copied in said copying the document information;
storing said keywords in said storage unit into the database in a condition where they are correlated to the document information in said storing unit; and
giving an addition of or changing said keywords in said storage unit to said keyword accepted in said accepting the keyword.

13. An information management program for controlling an apparatus that electronically saves, into a database, document information relating to documents and keywords which have been correlated to the document information in order to search for the document information and manages them, said program causing this apparatus to perform:
presenting contents of two different attributes, first and second ones, to be attached to said document information in order to classify said document information;
accepting said first and second; attributes to be attached to said document information, based on said contents of said first and second attribute presented in said presenting the contents;
storing first and second keyword option lists that correspond to said first and second attributes respectively, into a keyword list storage unit;
accepting switching between said first and second keyword option lists to be displayed on a keyword entry screen;
accepting, as a keyword to be correlated to said document information, entry of the keyword selected from the keyword option list displayed as a result of the switching on said keyword entry screen;
storing said keyword accepted in said accepting the entry of the keyword and said first and second attributes accepted in said accepting the attribute into said database in a condition where they are correlated to said document information;
specifying said first and second attributes and accepting them as a search range when searching said database for said document information saved in it;
accepting the keyword which is used in search, from said first and second keyword option lists respectively;
searching the document information saved in said search range accepted by said accepting the search range, for such document information as to correspond to said keyword; and
presenting said document information searched in said searching the document information, separately in each of said first attributes or for each of said second attributes.
